(19) United States
(12) Patent Application Publication
(10) Pub. No.: US 2014/0279424 A1
(43) Pub. Date: Sep. 18, 2014

(54) DEVICES, METHODS, AND SYSTEMS FOR TECHNOLOGICALLY SHIFTING OPTIONS AND MODALITIES

(71) Applicant: Elwha LLC, Bellevue, WA (US)

(72) Inventors: Pablos Holman, Seattle, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US)

(21) Appl. No.: 13/932,918

(22) Filed: Jul. 1, 2013

Related U.S. Application Data
(63) Continuation-in-part of application No. 13/843,118, filed on Mar. 15, 2013.
Application No. 13/843,118 is a continuation-in-part of application No. 13/907,565, filed on May 31, 2013.
Application No. 13/907,565 is a continuation-in-part of application No. 13/907,627, filed on May 31, 2013.

(51) Int. Cl. G06Q 20/10

(52) U.S. Cl. CPC G06Q 20/10
USPC 705/39

(57) ABSTRACT

Computationally implemented methods and systems include facilitating presentation of a persistent transaction interface, determining a vendor payment channel set for facilitating a potential transaction that corresponds to the presentation of the persistent transaction interface, and determining one or more resources configured to be used to carry out at least a portion of the potential transaction using at least one vendor payment channel from the determined at least one vendor payment channel set. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### Priority Applications:

For purposes of the USPTO extra-statutory requirements, the present application constitutes a continuation-in-part of U.S. patent application Ser. No. 13/843,118, entitled METHODS AND SYSTEMS FOR IMPLEMENTING VARIOUS TRANSACTIONAL ARCHITECTURES, naming Pablos Holman, Roderick A. Hyde, Royce A. Levien, Richard T. Lord, Robert W. Lord, and Mark A. Malamud as inventors, filed 15 Mar. 2013 with attorney docket no. 0213-003-001-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/907,565, entitled METHODS AND SYSTEMS FOR AGNOSTIC PAYMENT SYSTEMS, naming Pablos Holman, Roderick A. Hyde, Royce A. Levien, Richard T. Lord, Robert W. Lord, and Mark A. Malamud as inventors, filed 31 May 2013 with attorney docket no. 0213-003-002-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/907,627, entitled METHODS AND SYSTEMS FOR AGNOSTIC PAYMENT SYSTEMS, naming Pablos Holman, Roderick A. Hyde, Royce A. Levien, Richard T. Lord, Robert W. Lord, and Mark A. Malamud as inventors, filed 31 May 2013 with attorney docket no. 0213-003-045-000000, which is currently co-pending or is an application of which a currently co-pending application is entitled to the benefit of the filing date.

### Related Applications:

United States patent application No. To Be Assigned, entitled METHODS, SYSTEMS, AND DEVICES FOR HANDLING MULTIPLE DISPARATE SYSTEMS, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-003-000000, is related to the present application.

United States patent application No. To Be Assigned, entitled METHODS, SYSTEMS, AND DEVICES FOR HANDLING MULTIPLE DISPARATE SYSTEMS, naming Pablos Holman, Roderick A. Hyde, Royce A. Levien, Richard T. Lord, Robert W. Lord, and Mark A. Malamud as inventors, filed 1 Jul. 2013 with attorney docket no. 0213-003-046-000000, is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to data services.

### SUMMARY

In one or more various aspects, a method includes but is not limited to facilitating presentation of a persistent transaction interface, determining a vendor payment channel set for facilitating a potential transaction that corresponds to the presentation of the persistent transaction interface, and determining one or more resources configured to be used to carry out at least a portion of the potential transaction using at least one vendor payment channel from the determined at least one vendor payment channel set. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for affecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for facilitating presentation of a persistent transaction interface, means for determining a vendor payment channel set for facilitating a potential transaction that corresponds to the presentation of the persistent transaction interface, and means for determining one or more resources configured to be used to carry out at least a portion of the potential transaction using at least one vendor payment channel from the determined at least one vendor payment channel set. In addition to the foregoing, other system aspects are described in the claims, drawings, and text forming a part of the disclosure set forth herein.

In one or more various aspects, a system includes, but is not limited to, circuitry for facilitating presentation of a persistent transaction interface, circuitry for determining a vendor payment channel set for facilitating a potential transaction that corresponds to the presentation of the persistent transaction interface, and circuitry for determining one or more resources configured to be used to carry out at least a portion of the potential transaction using at least one vendor payment channel from the determined at least one vendor payment channel set. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for facilitating presentation of a persistent transaction interface, one or more instructions for determining a vendor payment channel set for facilitating a potential transaction that corresponds to the presentation of the persistent transaction interface, and one or more instructions for determining one or more resources configured to be used to carry out at least a portion of the potential transaction using at least one vendor payment channel from the determined at least one vendor payment channel set. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for facilitating presentation of a persistent transaction interface, one or more interchained physical machines ordered for determining a vendor payment channel set for facilitating a potential transaction that corresponds to the presentation of the persistent transaction interface, and one or more interchained physical machines ordered for determining one or more resources configured to be used to carry out at least a portion of the potential transaction using at least one vendor payment channel from the determined at least one vendor payment channel set.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1A-1AI, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1A-1AI are stitched together in the manner shown in FIG. 1E, which is reproduced below in table format.

TABLE 1
Table showing alignment of enclosed drawings to form partial
schematic of one or more environments.

| | | | | |
|---|---|---|---|---|
| (1, 1) - FIG. 1A | (1, 2) - FIG. 1B | (1, 3) - FIG. 1C | (1, 4) - FIG. 1D | (1, 5) - FIG. 1E |
| (2, 1) - FIG. 1F | (2, 2) - FIG. 1G | (2, 3) - FIG. 1H | (2, 4) - FIG. 1I | (2, 5) - FIG. 1J |
| (3, 1) - FIG. 1K | (3, 2) - FIG. 1L | (3, 3) - FIG. 1M | (3, 4) - FIG. 1N | (3, 5) - FIG. 1O |
| (4, 1) - FIG. 1P | (4, 2) - FIG. 1Q | (4, 3) - FIG. 1R | (4, 4) - FIG. 1S | (4, 5) - FIG. 1T |
| (5, 1) - FIG. 1U | (5, 2) - FIG. 1V | (5, 3) - FIG. 1W | (5, 4) - FIG. 1X | (5, 5) - FIG. 1Y |
| (6, 1) - FIG. 1Z | (6, 2) - FIG. 1AA | (6, 3) - FIG. 1AB | (6, 4) - FIG. 1AC | (6, 5) - FIG. 1AD |
| (7, 1) - FIG. 1AE | (7, 2) - FIG. 1AF | (7, 3) - FIG. 1AG | (7, 4) - FIG. 1AH | (7, 5) - FIG. 1AI |

FIG. 1A, when placed at position (1, 1), forms at least a portion of a partially schematic diagram of an environment(s) and/or an implementation(s) of technologies described herein.

FIG. 1B, when placed at position (1, 2), forms at least a portion of a partially schematic diagram of an environment(s) and/or an implementation(s) of technologies described herein.

FIG. 1C, when placed at position (1, 3), forms at least a portion of a partially schematic diagram of an environment(s) and/or an implementation(s) of technologies described herein.

FIG. 1D, when placed at position (1, 4), forms at least a portion of a partially schematic diagram of an environment(s) and/or an implementation(s) of technologies described herein.

FIG. 1E, when placed at position (1, 5), forms at least a portion of a partially schematic diagram of an environment(s) and/or an implementation(s) of technologies described herein.

FIG. 1F, when placed at position (2, 1), forms at least a portion of a partially schematic diagram of an environment(s) and/or an implementation(s) of technologies described herein.

FIG. 1G, when placed at position (2, 2), forms at least a portion of a partially schematic diagram of an environment(s) and/or an implementation(s) of technologies described herein.

FIG. 1H, when placed at position (2, 3), forms at least a portion of a partially schematic diagram of an environment(s) and/or an implementation(s) of technologies described herein.

FIG. 1I, when placed at position (2, 4), forms at least a portion of a partially schematic diagram of an environment(s) and/or an implementation(s) of technologies described herein.

FIG. 1J, when placed at position (2, 5), forms at least a portion of a partially schematic diagram of an environment(s) and/or an implementation(s) of technologies described herein.

FIG. 1K, when placed at position (3, 1), forms at least a portion of a partially schematic diagram of an environment(s) and/or an implementation(s) of technologies described herein.

FIG. 1L, when placed at position (3, 2), forms at least a portion of a partially schematic diagram of an environment(s) and/or an implementation(s) of technologies described herein.

FIG. 1M, when placed at position (3, 3), forms at least a portion of a partially schematic diagram of an environment(s) and/or an implementation(s) of technologies described herein.

FIG. 1N, when placed at position (3, 4), forms at least a portion of a partially schematic diagram of an environment(s) and/or an implementation(s) of technologies described herein.

FIG. 1O, when placed at position (3, 5), forms at least a portion of a partially schematic diagram of an environment(s) and/or an implementation(s) of technologies described herein.

FIG. 1P, when placed at position (4, 1), forms at least a portion of a partially schematic diagram of an environment(s) and/or an implementation(s) of technologies described herein.

FIG. 1Q, when placed at position (4, 2), forms at least a portion of a partially schematic diagram of an environment(s) and/or an implementation(s) of technologies described herein.

FIG. 1R, when placed at position (4, 3), forms at least a portion of a partially schematic diagram of an environment(s) and/or an implementation(s) of technologies described herein.

FIG. 1S, when placed at position (4, 4), forms at least a portion of a partially schematic diagram of an environment(s) and/or an implementation(s) of technologies described herein.

FIG. 1T, when placed at position (4, 5), forms at least a portion of a partially schematic diagram of an environment(s) and/or an implementation(s) of technologies described herein.

FIG. 1U, when placed at position (5, 1), forms at least a portion of a partially schematic diagram of an environment(s) and/or an implementation(s) of technologies described herein.

FIG. 1V, when placed at position (5, 2), forms at least a portion of a partially schematic diagram of an environment(s) and/or an implementation(s) of technologies described herein.

FIG. 1W, when placed at position (5, 3), forms at least a portion of a partially schematic diagram of an environment(s) and/or an implementation(s) of technologies described herein.

FIG. 1X, when placed at position (5, 4), forms at least a portion of a partially schematic diagram of an environment(s) and/or an implementation(s) of technologies described herein.

FIG. 1Y, when placed at position (5, 5), forms at least a portion of a partially schematic diagram of an environment(s) and/or an implementation(s) of technologies described herein.

FIG. 1Z, when placed at position (6, 1), forms at least a portion of a partially schematic diagram of an environment(s) and/or an implementation(s) of technologies described herein.

FIG. 1AA, when placed at position (6, 2), forms at least a portion of a partially schematic diagram of an environment(s) and/or an implementation(s) of technologies described herein.

FIG. 1AB, when placed at position (6, 3), forms at least a portion of a partially schematic diagram of an environment(s) and/or an implementation(s) of technologies described herein.

FIG. 1AC, when placed at position (6, 4), forms at least a portion of a partially schematic diagram of an environment(s) and/or an implementation(s) of technologies described herein.

FIG. 1AD, when placed at position (6, 5), forms at least a portion of a partially schematic diagram of an environment(s) and/or an implementation(s) of technologies described herein.

FIG. 1AE, when placed at position (7, 1), forms at least a portion of a partially schematic diagram of an environment(s) and/or an implementation(s) of technologies described herein.

FIG. 1AF, when placed at position (7, 2), forms at least a portion of a partially schematic diagram of an environment(s) and/or an implementation(s) of technologies described herein.

FIG. 1AG, when placed at position (7, 3), forms at least a portion of a partially schematic diagram of an environment(s) and/or an implementation(s) of technologies described herein.

FIG. 1AH, when placed at position (7, 4), forms at least a portion of a partially schematic diagram of an environment(s) and/or an implementation(s) of technologies described herein.

FIG. 1AI, when placed at position (7, 5), forms at least a portion of a partially schematic diagram of an environment(s) and/or an implementation(s) of technologies described herein.

FIG. 2A shows a high-level block diagram of an exemplary environment 200, according to one or more embodiments.

FIG. 2B shows a high-level block diagram of a personal device 220 operating in an exemplary environment 200, according to one or more embodiments.

FIG. 3, including FIGS. 3A-3F, shows a particular perspective of a potential transaction between user and client indicator acquiring module 252 of processing module 250 of personal device 220 of FIG. 2B, according to one or more embodiments.

FIG. 4, including FIGS. 4A-4C, shows a particular perspective of a vendor payment channel set including one or more of at least one vendor payment modality and at least one vendor payment option at least partial acquiring module 154 of processing module 150 of personal device 220 of FIG. 2B, according to one or more embodiments.

FIG. 5, including FIGS. 5A-5F, shows a particular perspective of an application of a user payment channel to at least one vendor payment channel of the acquired vendor payment channel set to facilitate the potential transaction module 156 of processing module 150 of personal device 220 of FIG. 2B, according to one or more embodiments.

FIG. 6 is a high-level logic flowchart of a process, e.g., operational flow 600, according to one or more embodiments.

FIG. 7A is a high-level logic flow chart of a process depicting alternate implementations of a facilitating presentation of a persistent transaction interface operation 602, according to one or more embodiments.

FIG. 7B is a high-level logic flow chart of a process depicting alternate implementations of a facilitating presentation of a persistent transaction interface operation 602, according to one or more embodiments.

FIG. 7C is a high-level logic flow chart of a process depicting alternate implementations of a facilitating presentation of a persistent transaction interface operation 602, according to one or more embodiments.

FIG. 7D is a high-level logic flow chart of a process depicting alternate implementations of a facilitating presentation of a persistent transaction interface operation 602, according to one or more embodiments.

FIG. 7E is a high-level logic flow chart of a process depicting alternate implementations of a facilitating presentation of a persistent transaction interface operation 602, according to one or more embodiments.

FIG. 7F is a high-level logic flow chart of a process depicting alternate implementations of a facilitating presentation of a persistent transaction interface operation 602, according to one or more embodiments.

FIG. 8A is a high-level logic flow chart of a process depicting alternate implementations of a determining a vendor payment channel set operation 604, according to one or more embodiments.

FIG. 8B is a high-level logic flow chart of a process depicting alternate implementations of a determining a vendor payment channel set operation 604, according to one or more embodiments.

FIG. 8C is a high-level logic flow chart of a process depicting alternate implementations of a determining a vendor payment channel set operation 604, according to one or more embodiments.

FIG. 9A is a high-level logic flow chart of a process depicting alternate implementations of a determining one or more resources operation 606, according to one or more embodiments.

FIG. 9B is a high-level logic flow chart of a process depicting alternate implementations of a determining one or more resources operation 606, according to one or more embodiments.

FIG. 9C is a high-level logic flow chart of a process depicting alternate implementations of a determining one or more resources operation 606, according to one or more embodiments.

FIG. 9D is a high-level logic flow chart of a process depicting alternate implementations of a determining one or more resources operation 606, according to one or more embodiments.

FIG. 9E is a high-level logic flow chart of a process depicting alternate implementations of a determining one or more resources operation 606, according to one or more embodiments.

FIG. 9F is a high-level logic flow chart of a process depicting alternate implementations of a determining one or more resources operation 606, according to one or more embodiments.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for facilitating presentation of a persistent transaction interface, determining a vendor payment channel set for facilitating a potential transaction that corresponds to the presentation of the persistent transaction interface, and determining one or more resources configured to be used to carry out at least a portion of the potential transaction using at least one vendor payment channel from the determined at least one vendor payment channel set.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user 105 is shown/described herein, e.g., in FIG. 1, and other places, as a single illustrated figure, those skilled in the art will appreciate that user 105 may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

In known systems, vendors offer payment channels for completing transactions. In known systems, users have payment channels that they want to use to carry out transactions. Sometimes, a user payment channel may be different than a vendor payment channel. For example, a user may not have her credit card present on her person, but may have her smartphone. The vendor may only accept credit card swipe with signature.

In an embodiment, the user device may manage payment channels for a user, so that when the vendor supplies a set of possible vendor payment channels, the user may select one or more of the payment channels based on one or more user preferences.

Referring now to FIG. 1, FIG. 1 illustrates an exemplary system environment in which one or more methods, systems, circuitry, articles of manufacture, and computer program products and architecture, in accordance with various embodiments, may interoperate. FIG. 1 may show one or more systems that may operate in coordination or independently. One or more portions of systems in FIG. 1 may operate as a complete system, or as a component of a larger system.

Referring now to FIG. 1, FIG. 1 shows a payment initiation module 2210. The payment initiation module may be part of user device 120, or may be a separate device. Payment initiation module 2210 may be any module that detects a user's intention to carry out one or more transaction. The detection of a user's intention to carry out one or more transactions may be relayed from another device, may be inferred, directly or indirectly, from user input, may be inferred from user action (e.g., a user places an item in a shopping cart, or pours a cup of coffee, or takes a bottle of wine off of a shelf), may be initiated by a person that is observing the user or otherwise interacting with the user (e.g., a barista at a coffee shop, or a technician in a mobile device store). In an embodiment, this module may be designed to provide the user with a seamless interface, e.g., the displaying of a “pay now” button, which will be described in more detail herein with respect to the “context sensitive pay button branch” observable extending to the left of payment initiation module 2210 in the context of FIG. 1. It is noted that the direction here and in other places throughout FIG. 1 was chosen merely for illustrative purposes and has no bearing or effect on the operation of the various modules and/or components of FIG. 1.

Referring again to FIG. 1, in an embodiment, payment initiation module 2210 may include payment initiation exemplary module 2210A, which is illustrated as a module that is designed to carry out an exemplary, non-limiting example embodiment, specifically, that a user desires to pay for an item that the user has selected at a store. In an example, the user has selected a bottle of wine, for which the user desires to pay. In this example, the user is in a wine store, but in another example, the store could be a virtual store, and the user could be in their home or at another location browsing a virtual store on a computer, tablet, mobile phone, or other device.

In an embodiment, payment initiation module 2210 may include simple payment initiation module that may initiate a simplified payment branching module, in which a user wants to pay for an item, or determine how much an item costs, or determine whether there is enough money (e.g., cash or cash equivalents, e.g., points, rewards, rebates, coupons, tokens, etc.) in one or more accounts e.g., an item the user has taken a picture of, or placed in a cart, or grabbed, or poured, e.g., coffee in a coffee shop or soda out of a soda dispenser, and the action initiates payment, or a negotiation for payment, for the item or service. In an embodiment, a user may be wearing augmented reality glasses, and may look at an item and make some sort of hand, eye, or bodily gesture (e.g., waving the hand across the face), or speak a particular command or set of words, that indicates that the user desires to pay for an item. In an embodiment, the payment initiation may be a time based event, e.g., the start of a movie, if a user has gotten concessions from an usher or a popcorn stand, or the like, or the start of a round or an inning of a sporting event, e.g., a baseball game. In an embodiment, the details of the payment channel negotiation, either for modality, option, or both, may be hidden from the user as the completion of a transaction. In an embodiment, there may be a fixed system, e.g., a user may go to a video arcade, and receive twenty tokens worth of credits, and the simple payment initiation occurs each time the user performs an action that debits a token, until the tokens are expended.

In an embodiment, a user may be placed in an environment where the user is allowed to select multiple items, products, or services, up to a limit, which may be time, credit, money, or token-based, e.g., a buffet, or a payment for five minutes in an electronics store, or a payment that allows a user to select twenty different resistors from a bin at an electronics store, e.g., a Radio Shack. In such an embodiment, the payment initiation module may handle the negotiation of payment and alert the user when the limit has been reached.

In an embodiment, the details of how the payment is negotiated are hidden from the user. For example, the manner in which the vendor acquires payment, e.g., whether over a Wi-Fi network, or the equivalent scanning of a bar code, or the entry of a PIN number, may be obscured from the user, who may receive simplified information indicating the success or failure of the transaction, or, in an embodiment, less information than that.

In an embodiment, as shown in FIG. 1, payment branching may lead to one or more portions of a user device 120 (e.g., following the red arrow “south” or “downward”). User device 120 may include, among other elements, a device memory 126. Device memory 126 may store one or more of a user payment option set and a user payment modality set.

In an embodiment, “payment” may refer to any portion of a transaction between a user and a vendor, including the selection and/or identification of an item and/or a service. As a tangible example, the scanning of a barcode on a can of peaches at a grocery store may be part of the “payment.” As another example, a barista keying in a description of a coffee order from a user into a computing device may also be part of a “payment.” Payment may also include authentication of a user to determine a user is the entity that the user is claiming to be. Payment is used merely as shorthand to refer to the entire process from start to finish of the acquisition of one or more goods and/or services by a user, and is not intended to be limited to the point of the transaction in which money and/or money equivalents change possession from the user to the vendor.

Under the terminology of this application, “payment modality” may refer to the mechanic by which payment information is exchanged between the vendor and the user. “Payment option” refers to the type of payment utilized by the user, and may refer to a type of credit card, a type of debit card, a type of electronic currency, and the like. The term “payment channel” may refer to one or both of “payment modality” and “payment option.”

Referring again to FIG. 1, FIG. 1 shows exemplary payment options 2120. Exemplary payment options 2120 are not intended to be an exhaustive list, but merely exemplary of some of the various types of payment options. For example, exemplary payment options 2120 may include one or more of credit card A 2122 (e.g., which may be a credit card that includes travel rewards, e.g., discounts on travel expenses), credit card B 2124 (e.g., which may be a card that accumulates fuel purchasing rewards, e.g., discounts on gasoline expenses), personal debit card 2126, corporate credit card 2128, PayPal account 2132, frequent shopper rewards card 2134, gift certificate 2136 and 2137 (e.g., which could refer to a specific gift certificate, e.g., “ten dollar Starbucks card” that can be redeemed only at a particular vendor, or a generic gift certificate, e.g., an “American Express gift card,” that is valid and redeemable regardless of the vendor, or a combination of the two (e.g., a gift card good at any hardware store, or any store in the downtown area of a city), instant credit approval 2138, cash 2142, foreign currency 2144, and cash equivalents 2146.

Referring again to FIG. 1, FIG. 1 shows exemplary payment modalities 2320. Exemplary payment modalities 2320 are not intended to be an exhaustive list, but merely exemplary of some of the various types of payment modalities. For example, exemplary payment modalities 2320 may include one or more of virtual currency (e.g., BitCoins, or Xbox points, and the like), one-dimensional (1-D) barcode scan 2358, credit card with swipe only 2322, credit card with swipe and personal identification number (PIN) entry 2324, biometric retinal scan 2339, biometric fingerprint scan 2342, two-dimensional (2-D) barcode scan 2356, color barcode scan 2362, credit card with swipe and signature 2325, device tap, e.g., near field communication technology 2332, audio speech recognition (e.g., identifying the words that are spoken) 2344, audio voice recognition (e.g., identifying the speaker that has spoken, e.g., voiceprint analysis, or other voice identification techniques, PIN and/or password only 2352, trusted device voucher 2354, device authentication over a wireless network 2334, device authentication over a cellular network 2336, credit card proximity (e.g., via Radio-Frequency Identification (RFID)) 2326, credit card microchip 2364, electronic funds transfer 2368, device proxy 2348 (e.g., where another, more complex device performs one or more steps in completing the payment process), and three-dimensional object identification 2372.

As shown in FIG. 1, exemplary payment options 2120 and exemplary payment modalities 2320 are illustrated as “clouds” in the drawings. This is to indicate that the payment options and the payment modalities can be substituted anywhere in the system without substantially changing the system. Specific examples may be given with specific payment options and payment modalities, but substitution with other options and/or modalities, whether listed as exemplary in this application or not listed, will not substantially change the operation of this architecture and should be considered as within the scope of this invention.

Referring again to FIG. 1, user device 120 may include user payment channel obtaining module 2240. User payment channel obtaining module 2240 may obtain the various user payment channels through one or more techniques, whether retrieving from device memory, scanning the device, polling different portions of the device, receiving and/or retrieving data from a remote location, or a combination of these. Payment channel obtaining module 2240 also may be dynamic, e.g., may determine that Wi-Fi is not available as a payment modality if there is no available open wireless network. Similarly, a user may disable various modalities, e.g., a user may want to stop using Credit Card A at a particular time, for example, if the user is approaching a credit limit. Payment channel obtaining module 2240 may include one or more of user payment option set obtaining module 2220 and user payment modality set obtaining module 2230. User payment option set obtaining module 2220 may be configured to obtain the payment option set for that user under a particular set of conditions, or generally. Similarly, user payment modality set obtaining module 2230 may be configured to obtain the payment modality set for that user under a particular set of conditions, or generally.

In an embodiment, user payment option set obtaining module 2220 may include user payment option set receiving module 2222. User payment option set receiving module 2222 may receive a user payment option set from a location. In an embodiment, the user payment option set, e.g., an exemplary user payment option set 3010A, may be received from cloud storage, e.g., network storage, e.g., user payment channel set cloud storage module 3010. User payment channel set cloud storage module 3010 may be any form of storage that is remote to user device 120, regardless of the owner of the network space, or the characteristics of the space, e.g., shared, dedicated, specific, and the like.

In an embodiment, user payment option set receiving module 2222 may receive a user payment option set, e.g., exemplary user payment option set 3020B, from a user payment channel set home/enterprise server storage module 3020. Module 3020 may be a home server, for example, or may be a related device to a device carried by a user. For example, user device 120 may be a watch, or a pair of glasses, that provides functionality to a user, whereas a payment option set is stored on a phone device carried by the user, or on a phone device carried by a related user, e.g., a user's mother, classroom teacher, boss, and the like.

In an embodiment, user payment channel obtaining module 2240 may include one or more of user payment option set receiving module 2222, user payment option set retrieving module 2224, and user payment option set generating module 2226. In an embodiment, user payment modality set obtaining module 2230 may include user payment modality set receiving module 2232, user payment modality set retrieving module 2234, and user payment modality set 2236. In an embodiment, one or more of these modules may work together to obtain one or more of the user payment option set and the user payment modality set. It is noted here that “set” may include a set of one payment option, or a set of one payment modality, or an empty set (e.g., there are no available payment options under the current conditions). It is further noted that “set” implies any structure, e.g., data structure, capable of representing, storing, manipulating, transmitting, conveying, displaying, or otherwise acting upon or for data.

In an embodiment, the user payment channel obtaining module 2240 obtains the user payment channel. Referring again to FIG. 1, as an example, the obtained user payment channel set, e.g., obtained user payment channel 2260, may include user payment option set 2262 and user payment modality set 2264. It is noted that these are merely exemplary user payment option sets and user payment modality sets, and other embodiments may include other sets of various size and content. Also, although the user payment option set 2262 and the user payment modality set 2264 are illustrated separately, this is merely for ease of understanding and illustration. In an embodiment, there may be a single set that includes part or all of a user payment option set and a user payment modality set, or multiple sets that contain one or more portions of one or more of the user payment option set and the user payment modality set.

In an embodiment, the obtained user payment channel set 2260 may include user payment option set 2262. As an example, and merely for the purposes of illustration, user payment option set 2262 may include credit card A 2122 and personal debit card 2126. In an embodiment, the obtained user payment channel set 2260 may include user payment modality set 2264. As an example, and merely for the purposes of illustration, user payment modality set 2264 may include device tap near-field communication 2332 and audio-voice 2346.

In an embodiment, user device 120 also may include vendor payment channel obtaining module 2410. Although pictured as part of user device 120, this is merely for illustrative purposes. In another embodiment, user device 120 may be external to user device 120, or may communicate over any form of network or any other form of communication. Moreover, vendor payment channel obtaining module 2410 may be interpreted in the illustration as operating after user payment channel obtaining module 2240. In an embodiment, vendor payment channel obtaining module 2410 may operate after user payment channel obtaining module 2240. In other embodiments, vendor payment channel obtaining module 2410 may operate concurrently or before, or on a different thread, processor, device, or system, as user payment channel obtaining module 2240.

In an embodiment, vendor payment channel obtaining module 2410 may include a vendor interface module 2412. Vendor interface module 2412 may be configured to receive a transmission of one or more vendor payment options and/or one or more vendor payment modalities. For example, in an embodiment, vendor interface module 2412 receives a broadcast from vendor device 6100, e.g., vendor payment channel set broadcasting module 2612. In an embodiment, vendor interface module 2412 may include vendor payment option set 2462 and vendor payment modality set 2464.

In an embodiment, vendor payment channel obtaining module 2410 may include vendor interface retrieving module 2414. Vendor interface retrieving module 2414 may retrieve one or more portions of one or more of the vendor payment option set, e.g., vendor payment option set 2462, and vendor payment modality set 2464. In an embodiment, vendor interface retrieving module 2414 may include vendor interface retrieving from vendor module 2416 and vendor interface retrieving from trusted device module 2418. In an embodiment, vendor payment channel obtaining module 2410 may include one or more of vendor payment channel determining module 2422 and vendor payment channel detecting module 2422.

In an embodiment, vendor payment channel obtaining module 2410 may include vendor scanning module 2430. In an embodiment, vendor scanning module 2430 may be configured to use one or more tools, e.g., hardware, software, or a combination thereof, to scan the surroundings of the user device 120, or to scan related networks for information about the surroundings of user device 120, in order to obtain information about one or more vendor payment channel sets. For example, vendor scanning module may acquire information through various forms, as indicated in module 2430A. For example, the user device may acquire data about vendor payment channels from one or more trusted devices, one or more devices in the proximity that are sharing or willing to share data, through Internet network resources (e.g., social networks, e.g., Twitter, Facebook, and the like), through one or more specific databases that may be proprietary and may be provided by one or more manufacturers of devices and/or device operating systems, e.g., Apple, Inc.

In an embodiment, module 2430 may include one or more databases which may be read by vendor scanning module 2430. With respect to module 2430, the “database” may be replaced with any data structure, or may represent data that is scattered across one or more networks and collected by one or more services, which may or may not be acting under the direction of user device 120. For example, module 2430 may include vendor information proprietary database 2431A, vendor information from search engine/data repository 2431B, vendor information from polling/querying area devices 2431C, vendor information from polling/querying trusted devices 2431D, and vendor information from publicly available data 2431E. In an embodiment, one or more of these or other sources may be used to obtain a vendor payment option set and/or a vendor payment modality set.

In an embodiment, vendor payment channel obtaining module 2410 may obtain one or more vendor payment channel sets 2460. In an embodiment, and for exemplary and/or illustrative purposes only, vendor payment channel set 2460 may include vendor payment option set 2462 and/or vendor payment modality set 2464. In an embodiment, and only for exemplary purposes, vendor payment option set 2462 may include credit card A 2122 and cash 2142. In an embodiment, and only for exemplary purposes, vendor payment modality set 2464 may include credit card swipe+PIN 2324 and credit card swipe+signature 2325. In an embodiment, this information may be gathered by vendor scanning module 2430, which, in an embodiment, may query the vendor's network to determine which modalities of payment are recognized. In an embodiment, the vendor scanning module 2430 may use false data to sample the systems of the vendor, to determine what capabilities for modalities and payment options are possessed by the vendor.

In an embodiment, when the user payment channel sets (e.g., user payment channel set 2260) and the vendor payment channel sets (e.g., vendor payment channel set 2460) have been obtained, then, in an embodiment, payment option comparator module 2500 and payment modality comparator module 2700 may compare the vendor payment option set and the vendor payment modality set, respectively. In the illustrated embodiment, payment option comparator module 2500 and payment modality comparator module 2700 are shown as separate modules, however, in other embodiments, they may be the same module, or scattered across various devices, or integrated into device 120. In an embodiment, a programmable chip, e.g., a central processing unit, or a portion thereof, may act as both payment modality comparator module 2700 at time A and payment option comparator module 2500 at time B. In an embodiment, payment option comparator module 2500 and payment modality comparator module 2700 may be a part of user device 120.

Referring again to FIG. 1, payment option comparator module 2500 may receive the vendor payment option set 2504 and the user payment option set 2506. In an embodiment, payment option comparator module 2508 may compare all or a portion of vendor payment option set 2504 and the user payment option set 2506. It is noted that the sets may be traversed in any known manner or form for comparison, and it is not required that the entire set of either the vendor payment option set 2504 or the user payment option set 2506 be traversed in their entirety. In an embodiment, payment option comparator module 2508 may receive user preference input 2520 and/or vendor preference input 2522, which may suggest an order in which the payment option or options are to be ranked, categorized, selected, or otherwise preferred, relative to one another or generally. Input from these modules is optional and may vary from system to system.

In an embodiment, payment option comparator module 2508 may determine that there is an overlap between vendor payment option set 2504 and user payment option set 2506. In an embodiment, overlapping set detection module 2510 may generate a calculated overlapping set 2535. It is noted that overlapping set 2535 is not required to be the entire overlapping set 2535. For example, in an embodiment, payment option comparator module 2508 may stop as soon as payment option comparator module 2508 finds one match, and that single match becomes the calculated overlapping set 2535, regardless of whether there are additional overlapping sets.

In an embodiment, payment option comparator module 2508 may determine that there is no overlap between vendor payment option set 2504 and user payment option set 2506. In an embodiment, no overlap in set detection module 2512 may transfer control to no-overlap interfacing module 2530. In an embodiment, if no overlap is detected between the vendor payment option set 2504 and the user payment option set 2506, then the no-overlap interfacing module 2530 may branch to a payment option interfacing module 2550.

For example, for exemplary purposes, in the illustrated example, “Credit Card A” 2122 is found both in the vendor payment option set 2504 and the user payment option set 2506. Thus, in an embodiment, overlapping set detection module 2510 may be invoked, and calculated overlapping set 2535 may include the set of “Credit Card A” 2122. In another embodiment, however, if there is no overlap, then payment option interfacing module 2550 may be invoked.

In an embodiment, payment option interfacing module 2550 may be part of user device 120. In an embodiment, payment option interfacing module 2550 may partially be a part of user device 120, and partially exterior or external to user device 120. In an embodiment, payment option interfacing module 2550 may include payment option supplier contact module 2552. In an embodiment, payment option supplier contact module 2552 may contact one or more payment option administrators to determine if the user's payment option set 2506 can be expanded to include a payment option that is part of the vendor's payment option set 2504. For example, in an embodiment, payment option supplier contact module 2552 may contact the administrator of one or more of the vendor's payment options, to see if the administrator of the payment option (e.g., the credit card company, e.g., Visa) may grant the user access to their payment system, either temporarily, as in a one-use credit card, or permanently, e.g., the granting of a persistent credit line to the user. In an embodiment, payment option supplier contact module 2552 may contact an electronic payment supplier, e.g., PayPal, or Amazon Payments, and request a one-use username and password that the user can use to interact with the vendor system, and then the electronic payment supplier can interface with one of the user payment options to receive reimbursement for processing the transaction with the vendor's payment option.

In an embodiment, payment option interfacing module 2550 may include manufacturer store as intermediary payment option module 2554. For example, in an embodiment, the manufacturer store as intermediary payment option module 2554 may contact an administrator of an online store, e.g., the Apple store, and determine if the Apple store will act as an intermediary to charge the device using its payment systems that are in place, and then handling the payment to the vendor.

In an embodiment, payment option interfacing module 2550 may include related device as intermediary payment option module 2556. For example, in an embodiment, related device as intermediary payment option module 2556 may find a related device that will pay for the item for the user. A related device may be a device that is in the user devices' contact list, or a device that is close to the user, or a device that is on a predetermined list that was approved by the device user, or a device that shares one or more characteristics with the user, or a device for which the same entity is responsible for paying the operating costs. For example, in an embodiment, if the user device 120 that is involved in the transaction is operated by a minor, then the minor's parent's device may be a related device, and may have additional payment options that can be used to interface with the vendor, on behalf of the minor.

In an embodiment, related device as intermediary payment option 2556 may include one or more of a contact list device search module 2558, a proximity device search module 2560, a predetermined device search module 2561, and/or a same-contract device search module 2562. One or more of these modules may be used to find a related device through one or more various methods, or through other methods not detailed here (e.g., through a social network accessed by the user device).

In an embodiment, payment option interfacing module 2550 may include unrelated device as intermediary payment option module 2564, which, in an embodiment, may include contracting device search module 2566 that is configured to search for devices that will take on a contract to assist the user device. For example, a person unrelated to the user may authorize their device to act as a payment intermediary. This intermediary could be nonspecific, could be specific to a store (e.g., only assist for Kohl's), could be specific to a type of stores (e.g., only assist for grocery stores), could be context-dependent (e.g., only assist for a store in which the device owner is currently located), or only authorize their device to act as payment intermediary for certain user payment option types (e.g., only assist for cash transactions). The user of the unrelated device, and the unrelated device, would then bear all or a part of the burden for negotiating reimbursement from the user device, plus whatever fee is allowed or negotiated, either by the unrelated device, by the vendor, by a third party, or by a governmental entity.

In an embodiment, payment option interfacing module 2550 may include selected payment option interface transmitting module 2568, which may be configured to transmit the selected payment option, and/or one or more details about the logistics of the payment option, to the device 120. It is noted that this transmission may be virtual or internal to the device 120, and may not include an actual “transmission,” but merely a handling of data.

In an embodiment, payment option comparator module 2500 may result in a selected payment option 2480, which, in an embodiment, and solely for exemplary purposes, may be credit card A 2122.

In an embodiment, payment modality comparator module 2700 may result in a selected payment modality 2490. Referring again to FIG. 1, in an embodiment, payment modality comparator module 2700 may include modality comparator exemplary module 2702, which may be configured to determine whether there is any overlap between the user payment modality set and the vendor payment modality set. In an example, e.g., the example shown in FIG. 1, exemplary vendor payment modality set 2704 may include credit card swipe+PIN 2324 and credit card swipe+signature 2326.

In an embodiment, payment modality comparator module 2700 may include payment option comparator module 2708. Referring again to FIG. 1, payment modality comparator module 2700 may receive the vendor payment modality set 2704 and the user payment modality set 2706. In an embodiment, payment modality comparator module 2708 may compare all or a portion of vendor payment modality set 2704 and the user payment modality set 2706. It is noted that the sets may be traversed in any known manner or form for comparison, and it is not required that the entire set of either the vendor payment modality set 2704 or the user payment modality set 2706 be traversed in their entirety. In an embodiment, payment modality comparator module 2708 may receive user preference input 2720 and/or vendor preference input 2722, which may suggest an order in which the payment modality or modalities are to be ranked, categorized, selected, or otherwise preferred, relative to one another or generally. Input from these modules is optional and may vary from system to system.

In an embodiment, payment modality comparator module 2708 may determine that there is an overlap between vendor payment modality set 2704 and user payment modality set 2706. In an embodiment, overlapping set detection module 2710 may generate a calculated overlapping set 2735. It is noted that overlapping set 2735 is not required to be the entire overlapping set 2735. For example, in an embodiment, payment modality comparator module 2708 may stop as soon as payment modality comparator module finds one match, and that single match becomes the calculated overlapping set 2735, regardless of whether there are additional overlapping sets.

In an embodiment, payment modality comparator module 2708 may determine that there is no overlap between vendor payment modality set 2704 and user payment modality set 2706. In an embodiment, no overlap in set detection module 2712 may transfer control to no-overlap interfacing module 2730. In an embodiment, if no overlap is detected between the vendor payment modality set 2704 and the user payment modality set 2706, then the no-overlap interfacing module 2730 may branch to a payment modality interfacing module 2640.

In an embodiment, e.g., in an illustrated example as shown in FIG. 1, there may be no overlap between exemplary vendor payment modality set 2704 and exemplary user payment modality set 2706. Thus, in an embodiment, no-overlap interfacing module 2730 may interface with payment modality interfacing module 2640, which may be part of device 120, separate from device 120, or a portion of which may be a part of device 120.

In an embodiment, payment modality interfacing module 2640 may include payment modality user-device as broker module 2650. In an embodiment, payment modality user-device as broker module 2650 facilitates the interface between a user payment modality and a vendor payment modality. For example, payment modality user-device as broker module 2650 may include vendor-accepted modality selecting module 2654 that is configured to select a modality that is acceptable to the vendor and that the device can broker. For example, the vendor may require a credit card swipe and PIN number as a modality. The user may have “audio—voice” as a modality because he or she does not want to physically swipe their card at a station. Thus, the device may act as a broker between the two modalities. Vendor-accepted modality selecting module 2654 may determine that, because it has a microphone to record and convert the PIN, and access to a credit card database, the device can act as a broker between the two modalities.

For example, payment modality user-device as broker module 2650 may include modality adaptation module 2654, which may be configured to take one or more steps in facilitating “conversion” of one modality supported by the device into another. This may be transparent to the user, or may require user assistance. In an embodiment, e.g., the illustrated embodiment, in step 2654EX1, the device may request the user to use the audio—voice modality to speak a PIN number into the microphone of the device, which is recorded. In an embodiment, in step 2654EX2, the device may convert the inputted audio into a PIN number in the format accepted by the vendor. In an embodiment, in step 2654EX3, the credit card data corresponding to a magnetic strip swipe data may be retrieved from a credit card database, e.g., a database run by the credit card company.

In an embodiment, payment modality user-device as broker module 2650 may include converted modality interfacing module 2656, which acts to transmit the converted swipe data and the PIN to the vendor, which treats the transaction as if the user had swiped his or her card and entered his or her PIN data.

In an embodiment, payment modality interfacing module 2640 may include payment modality related-device as broker module 2660. In an embodiment, payment modality related-device as broker module 2660 may include vendor-accepted modality selecting module 2654, which selects one or more of the vendor modalities (for which there is no overlap) that the device is capable of brokering with assistance from another device. In an embodiment, payment modality related-device as broker module 2660 also may include criterion-meeting related device acquiring module 2662, which may use one or more search techniques to find a related device that can assist the user device in completing the transaction. The search for a related device may be similar to that described above.

In an embodiment, criterion-meeting related device acquiring module 2662 may include one or more of contact list device search module 2662A, proximity device search module 2662B, predetermined device search module 2662C, and same-contract device search module 2662D.

In an embodiment, payment modality related-device as broker module 2660 may include related device instructing module 2664, which may be configured to instruct the related device found by module 2662 regarding how to interface the vendor modality with the user device. In an embodiment, this may include transmitting payment information to the related device so that the related device may engage the vendor modality.

In an embodiment, payment modality interfacing module 2640 may include payment modality vendor equipment as broker module 2670. In an embodiment, a vendor may provide equipment, which may be third-party produced, that allows additional modalities. For example, an internet currency provider (e.g., BitCoin) may outfit various Starbucks with devices that allow BitCoin transactions to be processed, using the device as an intermediary, without changing the Starbucks infrastructure. A user device may find these broker devices (which may not be implemented entirely in hardware) and use them to facilitate transactions, and may be invisible to the end user.

In an embodiment, payment modality vendor equipment as broker module 2670 may include vendor equipment communication module 2672. In an embodiment, payment modality vendor equipment as broker module 2670 may include vendor equipment interfacing module 2674. In an embodiment, payment modality vendor equipment as broker module 2670 may include data transmission to vendor equipment module 2676. In an embodiment, payment modality vendor equipment as broker module 2670 may include transaction monitoring module 2678.

In an embodiment, payment modality interfacing module 2640 may include payment modality unrelated device as broker module 2680. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner), similarly to the unrelated device as intermediary payment option module 2564.

In an embodiment, payment modality interfacing module 2640 may include selected payment modality interface transmitting module 2568, which may transmit the selected payment modality, which in an embodiment, the transmission may be internal to the device or within the workings of a particular application or module.

In an embodiment, the selected payment modality 2490 may be paired with the selected payment option into a selected payment option and modality 2750. The combination may not be literal, for example, it may be as simple as setting a flag indicating that a payment option and a payment modality have been selected. In an embodiment, the combination is omitted entirely, and shown in the illustration simply for ease of understanding the illustrated system.

In an embodiment, payment executing module 4000 may be a portion of the user device 120, or separate from the user device 120. Payment executing module 4000 may include vendor contacting module 4010 configured to contact the vendor to apply the payment. In an embodiment, payment executing module 4000 may include intermediary utilization applying module 4020, which may be configured to use any intermediaries, e.g., other devices, e.g., vendor devices, other user devices, other user's devices that are either related or unrelated to the user device, and the like, to assist in the carrying out of the payment.

In an embodiment, payment executing module 4000 may include intermediate steps module 4030, which may be used, for example, to convert one modality to the other, payment transmission module 4040 which may be used to transmit the payment using the selected modality, and confirmation receipt module 4050 which may communicate with the vendor to receive confirmation that the payment has been accepted.

Referring again to FIG. 1, in an embodiment, the payment initiation module 2210 may include a persistent payment button on the device module 2210C. In an embodiment, persistent payment button 2210C may represent a button that allows the user to pay, that does not change based on changing payment channels. It does not necessarily mean that the button is always present, although that may be the case in an embodiment. Persistent payment button 2210C may be a soft key or a hard key and may have a distinctive design or shape, and may be designed to be easy to access, in an embodiment. In an embodiment, persistent payment button 2210C may be a persistent payment soft button 7510. In an embodiment, the persistent payment soft button 7510 may be built into the device firmware. In another embodiment, the persistent payment soft button 7510 may be built into the operating system, or into another component or module of the device. In an embodiment, persistent payment button 2210C may be a physical, e.g., a hard button that is built into the device. For example, persistent payment button 2210C may be implemented as a persistent payment hard button 7512 that is built into the device. In another embodiment, persistent payment hard button 7512 may be programmed to operate as a persistent payment button under particular conditions, e.g., when a particular module is active, or when a particular condition is met. In an embodiment, for example, one or more devices with a persistent payment hard button 7512A may be provided when a user enters a retail store. For example, a wholesale superstore, e.g., a Wal-Mart, may hand out user devices having a persistent payment hard button 7512A to users as they enter the store, in order to facilitate one or more transactions.

In an embodiment, a module 2250 displays a single pay button on the user device. In an embodiment, module 2250 may include condition checking module 7522. Condition checking module 7522 may check one or more conditions to determine, e.g., when a particular module is active, or whether a particular condition is met. In an embodiment, module 2250 may include vendor communication maintaining module 7524. Vendor communication maintaining module 7524 may include a communication module for communicating with the vendor through one or more networks or other media. For example, a user device may communicate with the vendor through a closed vendor network, or through a wireless network provided by the vendor, or through a 4G LTE network provided by an unrelated communication network provider. In an embodiment, module 2250 may include payment channel monitoring module 7526. Module 7526 may monitor one or more payment channels of the user, the user device, or the vendor, and update if one or more of the monitored payment channels changes or becomes active or inactive.

In an embodiment, an input receiving module 7530 may receive input from the persistent payment button 2210C. For example, module 7530 may include button pushing receiving module 7533, which may detect when the persistent payment button 2210C is pressed. In another embodiment, however, persistent payment button 2210C may not be a button, but some other sort of non-button trigger, e.g., a gesture made while operating an augmented reality device, or an infrared signal. In an embodiment, non-button interface receiving module 7532 of input receiving module 7530 may receive the input indicating a potential transaction from the non-button implementation of the persistent payment button.

Then, in an embodiment, using methods previously described, a vendor payment channel acquiring module 2252 acquires an indication that the persistent payment button has been activated, and acquires, e.g., detects, receives, retrieves, or otherwise obtains, the vendor payment channel, e.g., using the vendor payment channel detecting module 2254, partly to detect the vendor payment channels. In an embodiment, vendor payment channel detecting module 2254 may access one or more external resources 2280, as previously described. Specifically, in an embodiment, the selected payment modality and option may be applied to execute the user's request to initiate payment, using the persistent payment button 2210C, and transparently, or partially transparently to the user, with the context of the device (e.g., location, and other factors) determining what specifically the persistent payment button 2210C carries out. In an embodiment, vendor payment channel acquiring module 2252 may include vendor transmission of payment options and/or payment modalities receiving module 7528, which may receive one or more payment options and/or one or more payment modalities from the vendor.

In an embodiment, multi-purpose device 7500 may also include an automated user payment channel selection module 7540, which, in an embodiment, may select a user payment channel for use in carrying out at least a portion of the transaction. In an embodiment, the selection may occur without user intervention. In another embodiment, the selection may include user intervention. Module 7540 may include one or more of payment channel comparator module 7542, weighted payment channel selecting module 7544, and payment channel selecting with non-user external automated input module 7546, which may select a user payment channel automatically, e.g., without further user input after the transaction has been initiated. In an embodiment, e.g., with the use of input module 7546, the process of selecting a user payment channel may be influenced or directly controlled by an external resource, which may or may not be related to the user or the user device.

In an embodiment, multi-purpose device 7500 may include selected automated user payment channel adaptation to one or more vendor payment channel modules 7550. For example, in an embodiment, module 7550 may include external resource for payment channel adapting module 2258, which may be configured to use one or more external resources to complete payment using a context-dependent vendor channel, e.g., through one or more external resources 2280.

In an embodiment, multi-purpose device 7500 may include potential transaction facilitating module 7560, which may include one or more communication modules for communicating with the vendor for which the potential transaction is being negotiated. In an embodiment, potential transaction facilitating module 7540 may include vendor payment systems communication module 7562.

In an embodiment, multi-purpose device 7500 may be implemented with one or more options or modifications. For example, in an embodiment, multi-purpose device 7500 may be implemented as described in payment option hard cap limiter 7520A. In that example, a user has more goods in his or her shopping cart than what he or she has funds to pay with using one or more user payment options of the user payment channel set. Using payment option hard cap limiter 7520A, a user may take items out of his or her shopping cart (which may exist in any known implementation, whether virtual or real), until a signal, e.g., the payment button changes or lights up, or some other appropriate signal, indicating that there are enough funds in the account to pay for the items.

In an embodiment, multi-purpose device 7500 may be implemented as payment option soft cap limiter example 7520B. For example, in an embodiment, a user may add things to his or her shopping car (which may be virtual or physical) until the button goes out, indicating he has overstepped how much funds are in the account, or how many funds have been allocated from the account for this purpose. For example, this could be implemented as a type of budgetary control (e.g., only allowed to spend up to $50 per month at Best Buy), or could be used by parents/spouses/siblings etc. to control spending (e.g., “my thirteen year old son can access my account to pay for things when he is at the comic book store today, but only up to twenty-five dollars).

In an embodiment, multi-purpose device 7500 may be implemented as gift card usage maximizer 7520C. For example, in an embodiment, a user may have an undetermined amount of value remaining on a gift card and the pay button may illuminate or otherwise change shape, form, status, or similar appearance when the items reach a certain value that is close to the total value of the gift card. For example, the payment bar could be realized in multi-colors, e.g., red and green, and the amount of green in the button indicates how much of the gift card would be utilized by the purchases currently in the shopping cart.

In an embodiment, multi-purpose device 7500 may communicate with a retail store front, e.g., retail store front 7570. In an embodiment, a device with a “pay” button, e.g., device 2121, may interface with the retail store front 7570. In an embodiment, a retail store front 7570 may include a receiving one or more devices configured to have a button that interacts and/or responds to the retail vendor module 7572, a distributing the one or more devices to one or more users upon entry to the retail dressage module 7574, a communicating with the one or more devices to change the button status based on one or more conditions module 7578 (e.g., it is noted that, in an embodiment, this module may be assisted by or controlled entirely by an external third party), and a facilitating one or more transactions in response to button pressing module 7579. In an embodiment, the modules listed above may be performed by a third party that is not the user or the vendor, but may or may not be related to one or both.

Referring again to FIG. 1, in an embodiment, payment initiation module 2210 may include simple payment initiation, which may allow for simple payment of one or more items that the user has indicated. For example, a user wants to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option. The initiation could also be a time-based event, e.g., the start of a movie, or of a round of a fight, or an inning of a baseball game (e.g., for purchase of concessions).

In an embodiment, there may be an augmented reality device 4100. Augmented reality device 4100 may be a device that is owned by the user, and may be associated with the user, e.g., a pair of glasses, or a watch, or it may be a device that is handed out by the vendor, e.g., similarly to how 3D glasses are handed out at movie theaters. Augmented reality device 4100 may include an actual device, and may also include one or more additional devices that support augmented reality device 4100, whether physically located in proximity to the user (e.g., carried by the user in his or her pocket, or worn) or remote to the user.

In an embodiment, augmented reality device 4100 may include duplication module 4110. Duplication module 4110 may be configured to allow a user to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option.

In an embodiment, augmented reality device 4100 may include a modality negotiation module 4210 may include a user payment modality preference retrieving module 4212 configured to retrieve a user payment modality preference. For example, if a user is sitting down in a crowded coffee shop, a user may be reluctant to get up to pay for a bagel, and risk losing her seat. In an embodiment, modality negotiation module 4210 may include vendor modality retrieving module 4214, which may retrieve a vendor payment modality similarly to one of the previously described techniques. For example, the device may detect, or is told, that a store in which the user is located only supports barcode payment or shopping cart modalities, but the user doesn't want to, or is physically incapable of, wait/waiting in a checkout line or self-checkout station. In an embodiment, modality selecting module 4220 may select a modality to carry out the user's request to pay for the item without additional help or input form the user. For example, modality selecting module 4220 may include modality interfacing database module 4222 and modality interfacing database data retrieving module 4224. For example, in an embodiment, if insufficient data is found in the modality interfacing database 4222, then external resources (e.g., Internet, Google, and an intranet of data from the device manufacturer) may be used to determine how to interface using a modality accepted by the vendor.

In an embodiment, once a modality is selected, and information about how to interface with that modality is attained, then modality interfacing module may interface using the vendor's preferred modality. For example, modality interfacing module 4230 may include, in an embodiment, for example, vendor modality duplication learning module 4232. For example, in the illustrated barcode modality example, the device may retrieve all or a portion of the store's barcode recognition database. It is noted that this retrieval may not involve the vendor, rather, in an embodiment, the device may retrieve this information from a third party that stores these databases, or from various manufacturers of items that the user has selected.

In an embodiment, vendor modality duplication implementing module 4234 may use the data gathered by vendor modality duplication learning module 4232, and use it to implement the data, e.g., in the example, retrieving the barcode of the item the user wants to purchase, e.g., by using an image processing sensor of the device.

In an embodiment, modality interfacing module 4230 also may include vendor modality duplication interfacing module 4236, which may be configured to interact with the vendor. For example, in the illustrated example, the vendor may have a vendor barcode reading device 6000. Vendor barcode reading device 6000 may include a barcode reader 6002, an input/output (which may be as simple as an LED) 6004, a store back-end 6008, and data processing unit 6006 that processes the data read by the barcode reader 6002. In an embodiment, vendor modality duplication interfacing module 4236 interacts with the data processing unit 6006 of the vendor barcode reading device 6000 to deliver the obtained barcode to the vendor, such that the vendor does not distinguish between the transmission and the usual use of the modality, scanning the barcode at the vendor barcode reading device 6000.

In an embodiment, modality interfacing module 4230 also may include a transaction completing module 4238, which completes the transaction and may inform the user.

In an embodiment, a vendor device and/or system 6100 may interact with the system as previously described. In an embodiment, vendor system 6100 may include a vendor payment channel set communicating module 2610. For example, vendor payment channel set communicating module 2610 may include vendor payment channel set broadcasting module 2612, which may be configured to broadcast information, e.g., using vendor payment option set broadcasting module 2612A and vendor payment modality set broadcasting module 2612B.

In an embodiment, vendor payment channel set communicating module 2610 may include one or more of vendor payment communication negotiation with user device module 2614, which may include vendor payment option communication negotiation with user device module 2614A and vendor payment modality communication negotiation with user device module 2614B, vendor payment channel set determining module 2616, and vendor payment channel set monitoring module 2618. In an embodiment, for example, an example vendor may have exemplary vendor payment modality set 2604EX, and exemplary vendor payment option set 2602EX, which have been previously described herein, and which are selected merely for exemplary purposes and are non-limiting.

In an embodiment, vendor device 6100 may include vendor mass payment with variable payment channels system 6200. For example, in various circumstances, a vendor may want to process payments from many users that use a plurality of modalities, e.g., in a movie theater, people may have items that they've purchased, or a set of people might be waiting in line for a new type of tablet device or video game. Vendor variable payment channels system 6200, in an embodiment, may be designed to facilitate all these people's different payment channels (modalities and options) and process them.

In an embodiment, vendor device 6100 may include vendor operation implementation module 2620, which describes how a vendor may implement a similar system as described with respect to user device 120. For example, in an embodiment, vendor operation implementation module 2620 may include vendor detection of a potential transaction module 2622. Module 2622 may detect that a transaction is about to take place, which may be based on vendor equipment, or based on a change in conditions, e.g., a position of a user. For example, module 2622 may be triggered, for example, by a user walking up to a self-checkout window in a grocery store, and hitting “start” on the screen.

In an embodiment, module 2620 may include a vendor payment channel obtaining module 2624. Vendor payment channel obtaining module 2624 may include vendor payment option obtaining module 2624A and vendor payment modality obtaining module 2624B. Vendor payment option obtaining module 2624A and vendor payment modality obtaining module 2624B may work similarly to their counterpart modules in the user device, e.g., vendor payment channel obtaining module 2410, with the exception that the vendor payment channel set may be stored locally.

In an embodiment of the invention, module 2620 may include a user payment channel obtaining module 2626. User payment channel obtaining module 2626 may include user payment option obtaining module 2626A and user payment modality obtaining module 2626B. Similarly to as above, user payment channel obtaining module 2626 may operate in a similar manner to user payment channel obtaining module 2240, except that because the user payment channel data will probably be remote to vendor device 6100, the techniques for obtaining payment channel data in module 2410 also may be used, as described herein.

In an embodiment of the invention, module 2620 may include a payment channel determining module 2628. Payment channel determining module 2628 may select one or more of a payment option and a payment modality, similarly to that which described with reference to module 2501. Also similarly to module 2501, external resources may be used, for example, as detailed in payment option interfacing module 2550 and payment modality interfacing module 2640.

In an embodiment of the invention, module 2620 may include transaction facilitating module using determined payment channel 2629, which may facilitate the transaction using the selected payment channel and payment modality, similarly to as described in module 4000.

In an embodiment of the invention, an application module 3500 may be implemented by a program or application designer. The application may reside at various levels within the device, e.g., the application may be part of the kernel, part of the firmware, part of the operating system. The application may be a preinstalled program or an essential program, or an independent program. The application may be implemented as an API or through any other known means of implementing an application, including hardware, software, firmware, programmable hardware, and others.

In an embodiment, an application module 3500 may include or interface with potential transaction detecting module 3510. In an embodiment, potential transaction detecting module 3510 may perform example 3510A of detecting a transaction or a potential for a transaction. In an embodiment, module 3510 may include one or more of device interface monitoring/communicating module 3512, device information gathering module 3514, device social network monitoring module 3516, device third party data regarding potential transaction receiving module 3518, and application communication with vendor facilitating module 3519.

In an embodiment, an application module 3500 may include or interface with a user payment channel obtaining module 3520. In an embodiment, user payment channel obtaining module 3520 may obtain, e.g., generate, receive, retrieve, or otherwise acquire a user payment channel from one or more sources. In an embodiment, user payment channel obtaining module 3520 may obtain a user payment channel set, and select a user payment channel from that user payment channel set. In an embodiment, user payment channel obtaining module 3520 may include one or more of application obtaining from device module 3522, application obtaining from vendor module 3524, application obtaining from third party module 3526, and application inferring module 3528.

In an embodiment, an application module 3500 may include or interface with a vendor payment channel obtaining module 3530. For example, in an embodiment, user vendor payment channel obtaining module 3530 may include obtaining the vendor payment channel from one or more sources 3530A. In an embodiment, vendor payment channel obtaining module 3530 may obtain a vendor payment channel set, and select one or more of a vendor payment option and/or a vendor payment modality, e.g., a vendor payment channel, from the vendor payment channel set. In an embodiment, vendor payment channel obtaining module 3530 may include one or more of application obtaining from device using device I/O module 3532, application obtaining from vendor directly module 3534, application obtaining from third party module 3536, application inferring module 3538, and application receiving vendor information from developer module 3539.

In an embodiment, an application module 3500 may include or interface with a payment channel set union obtaining module 3540, which, in an embodiment, may determine a usable payment channel set 3540A. In an embodiment, the payment channel set union obtaining module 3540 may include one or more of set comparator module 3542 and comparator output analyzing module 3544. In an embodiment, payment channel set union obtaining module 3540 may include or interface with empty set processing module 3560 or selected payment option and modality obtained from union set 3550 (e.g., which may include weighted union set analyzing module 3552), depending on whether there is union between a user payment channel set and a vendor payment channel set. If there is no union between the user payment channel set and the vendor payment channel set, processing moves to one or more of payment option interfacing module 2550 and/or payment modality interfacing module 2640, which are described in more detail elsewhere.

In an embodiment, vendor mass payment with variable payment channels system 6200 may include a device payment channel determining module 6210 configured to communicate with the device to determine a device's payment channel. In an embodiment, vendor mass payment with variable payment channels system 6200 also may include pay now instruction transmitting module 6212, and device payment acceptance module 6214, used to interface with the device modality as previously described. It is noted that the process by which this is carried out, as previously described with respect to user device 120, may take place at the vendor, at the user device, or partially at each of the devices, or using a third party device. In an embodiment, this process is repeated for all of the devices that are detected by the vendor mass payment with variable payment channels system 6200. It is noted that although system 6200 is called vendor mass payment with variable payment channels system 6200, that is merely for illustrative purposes, and in an embodiment, system 6200 may be provided by a third party, e.g., a device manufacturer, that may put limits on what kinds of devices are eligible for the mass payment system (e.g., only Samsung-branded phones are eligible, or only phones communicating on a 4G LTE network are eligible).

In an embodiment of the invention, a device, e.g., device 6500, may be used as a device intermediary, as previously described, with respect to module 2670. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner). In an embodiment, device 6500 may include a condition defined as acceptable for a device to act as an intermediary detecting module 6510. Module 6510 may perform calculations or receive instructions, e.g., from a user, or from a third party with limited agency over the device, that determine when device 6500 is allowed to act as an intermediary. For example, module 6510 may include determining one or more conditions that permit the device to act as an intermediary device for unrelated devices module 6512, which may determine a condition under which device 6500 will act as an intermediary. In an embodiment, module 6510 also may include a detecting one or more of the determined conditions that permit the device to act as an intermediary device for unrelated devices module 6514, which may detect, or be informed of, one or more acceptable conditions. An example of one or more conditions may be that a device is set to act as an intermediary to unrelated devices when the device is located at an upscale shopping mall. Another example may be that a device is set to act as an intermediary to unrelated devices when the device is located at a store that is part of a particular corporate chain. Another example may be that a device is set to act as an intermediary to unrelated devices when the device is located at a store that accepts a particular type of payments (e.g., Google Wallet).

In an embodiment of the invention, device 6500 may include availability as an intermediary informing module 6520, which communicates availability as an intermediary device to a variety of devices through one or more methods. In an embodiment, module 6520 may include one or more of signal broadcasting module 6522 for broadcasting a signal indicating availability as an intermediary that can be picked up by the client device, vendor communication and/or registration module 6524 for contacting the vendor and registering the device as available to perform intermediary work, listening for devices module 6526 for listening to communication involving one or more client devices and/or offering/soliciting as an intermediary, and third party requestor communication module for receiving communication from a non-vendor third party (e.g., a service provider to the vendor or to the client) requesting assistance as an intermediary 6528.

In an embodiment of the invention, device 6500 may include Intermediary acceptance module 6530 which may accept to act as an intermediary for the client device. This module may include intermediary compensation and/or agreement terms negotiating module 6532 and/or client data collecting module 6534. In an embodiment of the invention, device 6500 may include intermediary performance module 6540 for performing intermediary assistance in payment option and/or payment modality between client (user) and vendor.

Referring again to FIG. 1, a manufacturer marketplace may act as an intermediary, as described in step 2554. Such an intermediary may include developer marketplace 6600. For example, a store operated by the operating system manufacturer of the device (e.g., the Microsoft Xbox games store for a device running a Microsoft operating system, e.g., Windows Phone 8.0, receives a request to assist with a transaction, e.g., purchasing a coffee at a coffee shop). The marketplace may collect data regarding payment channels of the coffee shop and the client device that is attempting to purchase the coffee. The marketplace then may provide the payment to the vendor for a transaction, using a payment channel that the client device does not have access to, and then may use its own existing payment channel with the client device to recapture the cost of the transaction.

In an embodiment, marketplace 6600 may include request for payment channel assistance receiving module 6610. For example, an online shopping marketplace (e.g., a transaction facilitator, e.g., the Apple App Store, or Google Play Store) receives a request for assistance with one or more payment channels and/or payment modalities from the client device. In an embodiment, marketplace 6600 may include payment channel data gathering module 6620, which may be configured to gather information about the payment channels used by the client and the vendor, either directly from one or more of the client and/or vendor, or from other devices in the area.

In an embodiment, marketplace 6600 may include a payment channel vendor payment facilitating module 6630 configured to assist in providing payment to the vendor, utilizing one or more tools at its disposal, including possibly third party devices not under the direct control of the vendor, portions of the client device, the vendor device, or other resources.

In an embodiment, marketplace 6600 may include a payment channel client reimbursement facilitating module 6640 configured to, if necessary, if the vendor used one or more payment channels not directly involving the client device, the marketplace uses its payment channels, e.g., which may be preexisting due to the client relationship with the marketplace to collect the cost of the transaction from the client device. In another embodiment, marketplace 6600 may include marketplace as identifier tool module 6635 configured to may work with the vendor to confirm or certify an identity of the client device, in order to facilitate the transaction (e.g., which may be credit or accounts-payable based), rather than actually carry out the transaction.

Referring again to FIG. 1, e.g., FIG. 1C, other alternatives may be incorporated into the system. Some exemplary examples of these alternatives may include a frequent shopper reward application module 2160 that ensures that a user's frequent shopper cards are available as an option, or are automatically applied, a device search engine interface 2350, which goes to a search engine to get instructions to figure out how to interface with a particular payment channel, e.g., option or modality. In an embodiment, the system may include a credit card rewards program maximize module 2130 that may be configured to determine which credit card of a set of credit cards of the user to apply as the payment option to maximize user rewards, which may be based on an efficiency algorithm or a user preference that has been entered into the device.

In an embodiment, the system may include a trusted device voucher module 2354A, which, in an embodiment, in trying to verify the identity of a user, the vendor asks a device it trusts, e.g., a device it authenticates through a different means, to verify that the user device is legitimate. For example, a user's brother might not want to authenticate, or be unable to authenticate, so the user authenticates to the store with the user's device. The store then asks the user to verify that the person is indeed the user's brother. It could be limited to preexisting relationships, or types of relationships, e.g., blood relationships, marriage relationships, and familial relationships, or could use contact list information, or social network information.

In an embodiment, the system may include friendly device search interface 2360 configured to search the area to determine whether there are any devices that share a characteristic with the user device that ire in the vicinity.

In an embodiment, the system may include a small business assistance module 2140 configured to figure out whether a user wants to use a corporate card or not, e.g., based on one or more of where the user is located, what store the user is located in, what the user is buying, who the user is with, and the like.

In an embodiment, the system may include a frequent shopper card guaranteed use module 2150 configured to ensure that a user's frequent shopper card number is engaged when the purchase is completed, so that the user gets the credit.

Referring now to FIG. 2, FIG. 2 illustrates an example environment 200 in which the methods, systems, circuitry, articles of manufacture, and computer program products and architecture, in accordance with various embodiments, may be implemented by one or more user devices 220. As shown in FIG. 2A, one or more user devices 220, intermediate devices 230, external devices 240, and vendor devices 250 may communicate via one or more communication networks 240. In an embodiment, intermediate device(s) 230 may include intermediate device “A” 232 and/or intermediate device “B” 234. In an embodiment, vendor device 280 may include a vendor transaction processing system 282, a vendor interface system 284, and may include a vendor payment channel set 204, which may include one or more of a vendor payment modality set 204A and a vendor payment option set 204B. These will be discussed in more detail herein with respect to specific examples.

In an embodiment, external device 240 may include one or more of device list 242, vendor list 244, device communication interface 246, and vendor communication interface 248. Device 240 is listed as “external” not because it is necessarily external in temporal location or function, because in an embodiment, it may not be, but because external device 240 is not under the control of vendor device 280, user device 220, or intermediate device(s) 230, although any or all of the foregoing may communicate with external device 240.

User device 220 may be any electronic device, portable or not, that may be operated by or associated with one or more users. User device 220 is shown as interacting with a user 105. As set forth above, user 105 may be a person, or a group of people, or another entity that mimics the operations of a user. In an embodiment, user 105 may be a computer or a computer-controlled device. User device 220 may be, but is not limited to, a cellular phone, a network phone, a smartphone, a tablet, a music player, a walkie-talkie, a radio, a USB drive, a portable solid state drive, a portable disc-type hard drive, an augmented reality device (e.g., augmented reality glasses and/or headphones), wearable electronics, e.g., watches, belts, earphones, or “smart” clothing, earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

In an embodiment, user device 220 may be associated with user 105, and vendor device 280 may be associated with vendor 106. In an embodiment, user 105 may want to acquire goods and/or services from vendor 106, in what will be referred to throughout this application as a “transaction.” It is noted that “transaction” does not necessarily limit to the payment for a good or service. The transaction may incorporate such things as the user selecting an item, or requesting more information about an item from the vendor

In an embodiment, user 105 and user device 220 may facilitate the transaction using a user payment channel. A user payment channel may include one or more of a user payment modality and a user payment option. A user payment modality may be a method by which the user compensates the vendor for the one or more goods and services. A user payment option may be a specific type or form of payment that the user attempts to compensate the vendor for the goods or services. Examples of user payment options and user payment modalities are found in FIG. 1.

In an embodiment, vendor 106 and vendor device 280 may facilitate the transaction using a vendor payment channel. A vendor payment channel may include one or more of a vendor payment modality and a vendor payment option. A vendor payment modality may be a method by which the vendor compensates the vendor for the one or more goods and services. A vendor payment option may be a specific type or form of payment that the vendor attempts to compensate the vendor for the goods or services. Examples of vendor payment options and vendor payment modalities are found in FIG. 1.

In an embodiment, the user may wish to use the user payment channel to complete the transaction, regardless of what the vendor payment channel is. In an embodiment, the user may desire to not know what the vendor payment channel is, only that the transaction can be completed without the user changing his user payment channel to match the vendor payment channel. In an embodiment, there may be no overlap, or an incomplete overlap, between the user payment channel and the vendor payment channel. In such instances, the device may select a user payment channel, and then perform one or more operations to interface with the vendor payment channel. Specific examples of these types of operations will be described in more detail herein with respect to the figures. In an embodiment, the user device 220 may use one or more intermediate devices 230 in order to complete the transaction, or may use one or more external devices 240 that have resources that allow a vendor payment channel to be used by the device, even if the device does not necessarily support the vendor payment channel directly. In an embodiment, the user may remain unaware that the user payment channel is not being used for the entire transaction, e.g., the use of other resources and/or devices to complete the transaction may be hidden from the user. In an embodiment, the device interface may be simplified so that the user only presses a single button to carry out a transaction, and selection of a user payment channel and execution of the transaction using a vendor payment channel happens seamlessly, and without further input from the user.

Referring now to FIG. 2B, user device 220 may include an operating system 224 with a kernel 223. In this context, operating system 224 refers to any hardware, software, firmware, and combination thereof which is considered at the core or baseline of a device. For example, applications that interact directly with hardware may be considered to be part of an operating system. In an embodiment, operating system 224 may be an FPGA, printed circuit board, or other wired device. In an embodiment, operating system 224 may include one or more of Google's Android, Apple's iOS, Microsoft's Windows, various implementations of Linux, and the like. In an embodiment, operating system 224 may include a root menu for one or more televisions, stereo systems, media players, and the like. In an embodiment, operating system 224 may be a “home” or base screen of a device.

Referring again to FIG. 2B, in an embodiment, user device 220 may include a user interface 223. User interface 223 may include any hardware, software, firmware, and combination thereof that allow a user 105 to interact with a user device 220, and for the user device 220 to interact with a user 105. In an embodiment, user interface 223 may include a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, and the like.

Referring again to FIG. 2B, in an embodiment, personal device 220 may include a device memory 226. In an embodiment, device memory 226 may include memory, random access memory (“RAM”), read only memory (“ROM”), flash memory, hard drives, disk-based media, disc-based media, magnetic storage, optical storage, volatile memory, nonvolatile memory, and any combination thereof. In an embodiment, device memory 226 may be separated from the device, e.g., available on a different device on a network, or over the air. For example, in a networked system, there may be many user devices 220 whose device memory 226 is located at a central server that may be a few feet away or located across an ocean. In an embodiment, user device 220 may include a device memory 226. In an embodiment, memory 226 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In an embodiment, memory 226 may be located at a single network site. In an embodiment, memory 226 may be located at multiple network sites, including sites that are distant from each other.

Referring again to FIG. 2B, in an embodiment, user device 220 may include device interface component 228. In an embodiment, device interface component 228 includes any component that allows the device to interact with its environment. For example, in an embodiment, device interface component 228 includes one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, and the like. In an embodiment, device interface component 228 also may include one or more user interface components, e.g., user interface 225 (e.g., although they are drawn separately, in an embodiment, user interface 122 is a type of device interface component 128), and in an embodiment including one or more user input receiving components and output presenting components.

Referring again to FIG. 2B, FIG. 2B shows a more detailed description of user device. In an embodiment, user device 220 may include a processor 222. Processor 222 may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 222 may be a server. In an embodiment, processor 222 may be a distributed-core processor. Although processor 222 is as a single processor that is part of a single user device 220, processor 222 may be multiple processors distributed over one or many user devices 220, which may or may not be configured to operate together.

Processor 222 is illustrated as being configured to execute computer readable instructions in order to execute one or more operations described above, and as illustrated in FIGS. 6, 7A-7F, 8A-8C, and 9A-9C. In an embodiment, processor 222 is designed to be configured to operate as processing module 250, which may include one or more of potential transaction between user and client indicator acquiring module 252 vendor payment channel set including one or more of at least one vendor payment modality and at least one vendor payment option at least partial acquiring module 254, and application of a user payment channel to at least one vendor payment channel of the acquired vendor payment channel set to facilitate the potential transaction module 256.

Referring now to FIG. 3, FIG. 3 illustrates an exemplary implementation of the potential transaction between user and client indicator acquiring module 252. As illustrated in FIG. 3, the potential transaction between user and client indicator acquiring module may include one or more sub-logic modules in various alternative implementations and embodiments. For example, as shown in FIG. 3, e.g., FIG. 3A, in an embodiment, module 252 may include abiding device-based interchange presentation using a device as a medium for presentation facilitating module 302. In an embodiment, module 302 may include abiding device-based interchange presentation using a device associated with a client as a medium for presentation facilitating module 304. In an embodiment, module 304 may include abiding device-based interchange displaying using a projection device associated with a client as a medium for presentation facilitating module 306. In an embodiment, module 306 may include abiding device-based selectable switch displaying using a projection device associated with a client as a medium for presentation facilitating module 308. In an embodiment, module 308 may include abiding device-based transaction initiating switch displaying using a projection device associated with a client as a medium for presentation facilitating module 310. In an embodiment, module 310 may include same parameter device-based transaction initiating switch displaying using a projection device associated with a client as a medium for presentation facilitating module 312. In an embodiment, module 312 may include transaction initiating switch disposed at a same location with a same parameter under one or more particular device conditions displaying using a projection device associated with a client as a medium for presentation facilitating module 314.

Referring again to FIG. 3, e.g., FIG. 3B, in an embodiment, module 252 may include one or more of abiding device-based interchange presentation with a same characteristic independently of one or more vendor payment channels of the vendor payment channel set facilitating module 316 and abiding device-based interchange presentation with a same characteristic independently of one or more user payment channels facilitating module 320. In an embodiment, module 316 may include abiding device-based interchange presentation with a same characteristic independently of a first vendor payment channel of the vendor payment channel set and a second vendor payment channel facilitating module 318. In an embodiment, module 320 may include abiding device-based interchange presentation with a same characteristic independently of a first client payment channel and a second client payment channel facilitating module 322.

Referring again to FIG. 3, e.g., FIG. 3C, in an embodiment, module 252 may include abiding device-based interchange visual display facilitating module 324. In an embodiment, module 324 may include abiding device-based interchange visual display having an abiding property facilitating module 326. In an embodiment, module 326 may include one or more of abiding device-based interchange visual display having an abiding relative display position property facilitating module 328, abiding device-based interchange visual display having an abiding visual property facilitating module 330, and one or more instructions overriding the abiding device-based interchange visual display interrupting module 332. In an embodiment, module 332 may include one or more instructions overriding the abiding device-based interchange visual display modifying module 334.

Referring again to FIG. 3, e.g., FIG. 3D, in an embodiment, module 252 may include one or more of abiding device-based interchange presentation that is configured to initiate at least a portion of a potential transaction facilitating module 336 and abiding device-based interchange presentation at least partially using mixed-reality facilitating module 342. In an embodiment, module 336 may include one or more of abiding dual-state device-based interchange presentation that is configured to initiate at least a portion of a potential transaction facilitating module 338 and abiding dual-state vendor-provided device-based interchange presentation that is configured to initiate at least a portion of a potential transaction facilitating module 340. In an embodiment, module 342 may include abiding device-based interchange presentation at least partially using an augmentation in a mixed-reality facilitating module 344. In an embodiment, module 344 may include one or more of abiding device-based interchange presentation at least partially using a mixed-reality multi-state switch facilitating module 346 and abiding device-based interchange presentation at least partially using a virtual heads-up display facilitating module 348.

Referring again to FIG. 3, e.g., FIG. 3E, in an embodiment, module 252 may include abiding device-based interchange presentation configured to receive articulated gesture input facilitating module 350. In an embodiment, module 350 may include one or more of abiding device-based interchange presentation configured to receive one or more extremity movements as input facilitating module 352 and abiding device-based interchange presentation configured to receive one or more eye movements as input facilitating module 354.

Referring again to FIG. 3, e.g., FIG. 3F, in an embodiment, module 252 may include abiding device-based interchange presentation facilitating at a device configured to carry out at least a portion of one or transactions module 356. In an embodiment, module 356 may include one or more of abiding device-based interchange presentation facilitating at a shopping cart module 358, abiding device-based interchange presentation facilitating at a vending machine module 360, abiding device-based interchange presentation facilitating at an automated teller machine module 362, and abiding device-based interchange presentation facilitating at a movie theater seating device module 364.

Referring now to FIG. 4, FIG. 4 illustrates an exemplary implementation of vendor payment channel set including one or more of at least one vendor payment modality and at least one vendor payment option at least partial acquiring module 254. As illustrated in FIG. 4, the vendor payment channel set including one or more of at least one vendor payment modality and at least one vendor payment option at least partial acquiring module 254 may include one or more sub-logic modules in various alternative implementations and embodiments. For example, as shown in FIG. 4 (e.g., FIG. 4A), in an embodiment, module 254 may include vendor payment channel set related to a potential transaction that is configured to be triggered by receipt of an internal signal received from the abiding device-based interchange acquiring module 402. In an embodiment, module 402 may include vendor payment channel set including one or more of at least one vendor payment modality and at least one vendor payment option related to a potential transaction that is configured to be triggered by receipt of an internal signal received from the abiding device-based interchange acquiring module 404. In an embodiment, module 404 may include vendor payment channel set including one or more of at least one vendor payment modality and at least one vendor payment option related to a potential transaction that is configured to be triggered by receipt of an internal signal received from the abiding device-based interchange acquiring module 406. In an embodiment, module 406 may include one or more of vendor payment channel set including one or more of at least one vendor payment modality including a near-field communication modality and at least one vendor payment option including a bank card option related to a potential transaction that is configured to be triggered by receipt of an internal signal received from a soft key of the abiding device-based interchange acquiring module 408 and vendor payment channel set including one or more of at least one vendor payment modality including a near-field communication modality and at least one vendor payment option including a bank card option related to a potential transaction that is configured to be triggered by receipt of an internal signal received from a soft key of the abiding vendor-provided device-based interchange acquiring module 410.

Referring again to FIG. 4, e.g., FIG. 4B, in an embodiment, module 254 may include one or more of vendor payment channel set related to a potential transaction determining upon generation of the abiding device-based interchange module 412, vendor payment channel set related to a potential transaction that is configured to be determined prior to facilitating presentation of the abiding device-based interchange acquiring module 416, vendor payment channel set configured to facilitate a potential transaction determining module 418, and abiding device-based interchange presentation facilitating after determination of vendor payment channel set 420. In an embodiment, module 412 may include vendor payment channel set including one or more of at least one vendor payment modality and at least one vendor payment option related to a potential transaction determining upon generation of a mixed-reality abiding device-based interchange module 414. In an embodiment, module 420 may include one or more of abiding device-based interchange presentation deobscuring upon determination of vendor payment channel set 422 and abiding device-based interchange presentation presenting only upon determination of vendor payment channel set 426. In an embodiment, module 422 may include abiding device-based interchange presentation deobscuring by restoring a presentation characteristic of the abiding device-based interchange upon determination of vendor payment channel set 424.

Referring again to FIG. 4, e.g., FIG. 4C, in an embodiment, module 254 may include one or more of vendor payment channel set that is configured to facilitate a potential transaction determining module 428, abiding device-based interchange that is configured to use at least one vendor payment channel of the vendor payment channel presentation handling module 430, vendor payment channel set related to a potential transaction that is configured to be triggered by interaction with the abiding device-based interchange that obscures the vendor payment channel set acquiring module 434, and vendor payment channel set having a single vendor payment channel related to a potential transaction that is configured to be triggered by interaction with the abiding device-based interchange acquiring module 436. In an embodiment, module 430 may include abiding device-based interchange that is configured to use at least one vendor payment channel of the vendor payment channel presentation handling to prevent presentation when the vendor payment channel set is an empty set module 432. In an embodiment, module 436 may include vendor payment channel set having a single vendor payment channel having a single vendor payment modality related to a potential transaction that is configured to be triggered by interaction with the abiding device-based interchange acquiring module 438.

Referring now to FIG. 5, FIG. 5 illustrates an exemplary implementation of application of a user payment channel to at least one vendor payment channel of the acquired vendor payment channel set to facilitate the potential transaction module 256. As illustrated in FIG. 5, the application of a user payment channel to at least one vendor payment channel of the acquired vendor payment channel set to facilitate the potential transaction module 256 may include one or more sub-logic modules in various alternative implementations and embodiments. For example, as shown in FIG. 5, e.g., FIG. 5A, in an embodiment, module 256 may include one or more of one or more databases related to carrying out at least a portion of the potential transaction using the acquired vendor payment channel set locating module 502, one or more vendor-specific data translation tables related to carrying out at least a portion of the potential transaction using the acquired vendor payment channel set locating module 504, located one or more vendor-specific data translation tables retrieving module 506, and one or more resource addresses related to carrying out at least a portion of the potential transaction using the acquired vendor payment channel set determining module 508. In an embodiment, module 508 may include one or more credit card data storage addresses related to carrying out at least a portion of the potential transaction using the acquired vendor payment channel set determining module 510.

Referring again to FIG. 5, e.g., FIG. 5B, in an embodiment, module 256 may include one or more resources related to carrying out at least a portion of the potential transaction using the acquired vendor payment channel set and configured to transform transaction data for use by at least one vendor payment channel of the vendor payment channel set locating module 512. In an embodiment, module 512 may include one or more resources related to carrying out at least a portion of the potential transaction using the acquired vendor payment channel set and configured to transform transaction data for use by at least one vendor payment channel of the vendor payment channel set locating on a device configured to present the abiding device-based interface module 514. In an embodiment, module 514 may include one or more resources related to carrying out at least a portion of the potential transaction using the acquired vendor payment channel set and configured to transform client payment channel data for use by at least one vendor payment channel of the vendor payment channel set locating on a device configured to present the abiding device-based interface module 516. In an embodiment, module 516 may include one or more of one or more resources related to carrying out at least a portion of the potential transaction using the acquired vendor payment channel set and configured to transform client payment channel data of a client payment channel set for use by at least one vendor payment channel of the vendor payment channel set locating on a device configured to present the abiding device-based interface module 518 and one or more resources related to carrying out at least a portion of the potential transaction using the acquired vendor payment channel set and configured to transform client payment channel data of one or more of at least one client payment modality and at least one client payment option for use by at least one vendor payment channel of the vendor payment channel set locating on a device configured to present the abiding device-based interface module 520.

Referring again to FIG. 5, e.g., FIG. 5C, in an embodiment, module 256 may include one or more resources related to carrying out at least a portion of the potential transaction using the acquired vendor payment channel set and configured to manipulate transaction data for use by at least one vendor payment channel of the vendor payment channel set locating module 522. In an embodiment, module 522 may include one or more external resources related to carrying out at least a portion of the potential transaction using the acquired vendor payment channel set and configured to manipulate transaction data for use by at least one vendor payment channel of the vendor payment channel set locating module 524. In an embodiment, module 524 may include one or more of one or more external resources controlled by a device component provider and related to carrying out at least a portion of the potential transaction using the acquired vendor payment channel set and configured to manipulate transaction data for use by at least one vendor payment channel of the vendor payment channel set locating module 526, one or more external resources controlled by a communication network provider and related to carrying out at least a portion of the potential transaction using the acquired vendor payment channel set and configured to manipulate transaction data for use by at least one vendor payment channel of the vendor payment channel set locating module 528, one or more external resources controlled by a vendor and related to carrying out at least a portion of the potential transaction using the acquired vendor payment channel set and configured to manipulate transaction data for use by at least one vendor payment channel of the vendor payment channel set locating module 530, and one or more external resources having a particular proximity to a vendor and related to carrying out at least a portion of the potential transaction using the acquired vendor payment channel set and configured to manipulate transaction data for use by at least one vendor payment channel of the vendor payment channel set locating module 532.

Referring again to FIG. 5, e.g., FIG. 5D, in an embodiment, module 256 may include modules 522 and 524, as previously described. In an embodiment, module 522 may include one or more of list of one or more external resources configured to manipulate transaction data for use by at least one vendor payment channel of the vendor payment channel set acquiring module 534 and external resource from the acquired list of one or more external resources selecting module 536. In an embodiment, module 534 may include list of one or more external resources configured to manipulate transaction data for use by at least one vendor payment channel of the vendor payment channel set acquiring from a vendor using the vendor payment channel set module 538. In an embodiment, module 536 may include external resource from the acquired list of one or more external resources selecting based on a common characteristic with a device configured to present the abiding device-based interchange module 540. In an embodiment, module 540 may include external resource from the acquired list of one or more external resources selecting based on having one or more same applications as the device configured to present the abiding device-based interchange module 542.

Referring again to FIG. 5, e.g., FIG. 5E, in an embodiment, module 256 may include modules 522, 524, 534, and 536, as previously described. In an embodiment, module 536 may include one or more of external resource from the acquired list of one or more external resources selecting based on a price quoted for a use of the external resource module 544 and external resource from the acquired list of one or more external resources selecting based on a pre-existing relationship between the external resource and a device configured to present the abiding device-based interchange resource module 546.

Referring again to FIG. 5, e.g., FIG. 5F, in an embodiment, module 256 may include one or more of one or more resources related to carrying out at least a portion of the potential transaction using the acquired vendor payment channel set and associated with a device configured to present the abiding device-based interface locating module 548 and one or more applications configured to carry out at least a portion of the potential transaction using the acquired vendor payment channel set identifying module 552. In an embodiment, module 548 may include one or more resources related to carrying out at least a portion of the potential transaction using the acquired vendor payment channel set and operating under a related contract with a device configured to present the abiding device-based interface locating module 550. In an embodiment, module 552 may include one or more of one or more applications configured to store data that assist in carrying out at least a portion of the potential transaction using the acquired vendor payment channel set identifying module 554, one or more applications configured to have a permission to access data that assist in carrying out at least a portion of the potential transaction using the acquired vendor payment channel set identifying module 556, and device analyzing to identify one or more applications configured to carry out at least a portion of the potential transaction using the acquired vendor payment channel set module 558.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 6 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIGS. 7-9 as well as the other operations to be described herein may be performed by at least one of a machine, an article of manufacture, or a composition of matter.

It is noted that, associated does not require physical proximity. A device could be associated with a user if the user purchased that device, or stores information on that device, or has ever logged in and identified herself to that device. In addition, a device may be associated with a user if the user holds the device, carries the device, operates the device, or is assigned the device.

It is noted that “indicator” and “indication” may, in various embodiments, refer to many different things, including any of electronic signals (e.g., pulses between two components), human-understandable signals (e.g., information being displayed on a screen, or a lighting of a light, or a playing of a sound), and non-machine related signals (e.g., two people talking, a change in ambient temperature, the occurrence of an event, whether large scale (e.g., earthquake) or small-scale (e.g., the time becomes 4:09 p.m. and 32 seconds), alone or in any combination.

Referring now to FIG. 6, FIG. 6 shows operation 600, e.g., an example operation of a device 220 operating in an environment 200. In an embodiment, operation 600 may include operation 602 depicting facilitating presentation of a persistent transaction interface. For example, FIG. 2, e.g., FIG. 2B, shows abiding device-based interchange presentation facilitating module 252 facilitating (e.g., performing one or more actions that assist in the execution or completion of) presentation (e.g., show, through any combination of visual and non-visual interfaces, whether on a device (e.g., on a screen), through a device (e.g., projected, whether two- or three-dimensional, or presented using any sensory input (e.g., buzzing a wearable item of clothing, making a noise in a headphone or speaker, and similar presentations)) of a persistent transaction interface (e.g., an interface, (e.g., a connection, whether physical, virtual, temporary, or permanent, for interacting with an object, e.g., a device) that persists through one or more particular conditions (e.g., is always present when the device is powered on (e.g., a soft button displayed or projected by a device), or is always present on the device at all times (e.g., a physical button on the device, or is always present when certain conditions are met (e.g., when a particular vendor to talk to is detected, or when an item is placed in a shopping cart), or when a particular application, including but not limited to operating systems or other kernel-type applications, are active on a device).

Referring again to FIG. 6, operation 600 may include operation 604 depicting determining a vendor payment channel set for facilitating a potential transaction that corresponds to the presentation of the persistent transaction interface. For example, FIG. 2, e.g., FIG. 2B, shows determining (e.g., receiving, calculating, generating, selecting, manipulating, retrieving, or otherwise obtaining, and equivalents) a vendor payment channel set (e.g., a set, which in some embodiments may include the empty set, of one or more of a vendor payment option (e.g., a form of a medium of exchange, e.g., money, currency, credit, and equivalents) and/or one or more of a vendor payment modality (e.g., a method of performing the exchange, a medium by which the exchange takes place, a facilitator of exchange of compensation, and equivalents, that the vendor has available to him or her)) for facilitating (e.g., performing one or more actions that assist in the execution or completion of) a potential transaction (e.g., an exchange of a form of compensation for goods and/or services, whether it actually occurs or not, at any stage, including preparation, selection of an item, verification of a price, verification of an identity, and equivalents) that corresponds to (e.g., an interaction with the persistent transaction interface may trigger at least a portion of the potential transaction) the presentation (e.g., e.g., show, through any combination of visual and non-visual interfaces, whether on a device (e.g., on a screen), through a device (e.g., projected, whether two- or three-dimensional, or presented using any sensory input (e.g., buzzing a wearable item of clothing, making a noise in a headphone or speaker, and similar presentations)) of the persistent transaction interface (e.g., an interface, (e.g., a connection, whether physical, virtual, temporary, or permanent, for interacting with an object, e.g., a device) that persists through one or more particular conditions (e.g., is always present when the device is powered on (e.g., a soft button displayed or projected by a device), or is always present on the device at all times (e.g., a physical button on the device, or is always present when certain conditions are met (e.g., when a particular vendor to talk to is detected, or when an item is placed in a shopping cart), or when a particular application, including but not limited to operating systems or other kernel-type applications, are active on a device).

Referring again to FIG. 6, operation 600 may include operation 606 depicting determining one or more resources configured to be used to carry out at least a portion of the potential transaction using at least one vendor payment channel from the determined at least one vendor payment channel set. For example, FIG. 2, e.g., FIG. 2B, shows determining (e.g., receiving, calculating, generating, selecting, manipulating, retrieving, or otherwise obtaining, and equivalents) one or more resources (e.g., resources here includes any or all of data, applications, hardware, software, information, network, a provider of any of the foregoing, and/or any combination thereof) configured to be (e.g., designed to be, and note that included in this are situations with a simulated transaction prior to any actual transactions taking place) used (e.g., have a property that makes them usable under one or more conditions) to carry out (e.g., execute or attempt to execute at least a portion of) at least a portion of the potential transaction (e.g., an exchange of a form of compensation for goods and/or services, whether it actually occurs or not, at any stage, including preparation, selection of an item, verification of a price, verification of an identity, and equivalents) using at least one vendor payment channel (e.g., at least one vendor payment option (e.g., a form of a medium of exchange, e.g., money, currency, credit, and equivalents) and/or at least one vendor payment modality (e.g., a method of transmitting compensation that the vendor has available to him or her)) from the determined at least one vendor payment channel set (e.g., a set, which in some embodiments may include the empty set, of one or more of a vendor payment option (e.g., a form of a medium of exchange, e.g., money, currency, credit, and equivalents) and/or one or more of a vendor payment modality (e.g., a method of performing the exchange, a medium by which the exchange takes place, a facilitator of exchange of compensation, and equivalents, that the vendor has available to him or her)).

In an embodiment, a payment option may include, but is not limited to, one or more of a form of compensation that the vendor may accept, e.g., credit card alpha, credit card beta, store credit card, fuel rewards card, bank gamma debit card, bank delta debit card, corporate credit card, PayPal account, frequent shopper rewards card, nonspecific gift certificate, vendor-specific gift certificate, instant credit approval mechanism, cash, casino chips, tokens, foreign currency, BitCoins, travelers check, bearer bonds, game system points, store credit. The foregoing examples are provided for exemplary purposes only to aid in comprehension of embodiments of the invention and should not be considered an exhaustive or all-inclusive list.

In an embodiment, a payment modality may include, but is not limited to, one or more of credit card verification with swipe only, credit card verification with personal identification number (“PIN”) entry, credit card verification with signature, credit card verification with physical card proximity using radio frequency identifiers (“RFID”), device tap using near field communication (“NFC”), device authentication via wireless network, device authentication via cellular network, indirect device authentication via a device manufacturer network, retinal scan, fingerprint scan, speech recognition, voice recognition, device proxy, password only, trusted device voucher, quick response code, one-dimensional bar code, color barcode, card-embedded microchip, virtual currency transaction, electronic funds transfer, three-dimensional object verification, check authorization, cash anti-counterfeiting procedure. The foregoing examples are provided for exemplary purposes only to aid in comprehension of embodiments of the invention and should not be considered an exhaustive or all-inclusive list.

FIGS. 7A-7E depict various implementations of operation 602, depicting facilitating presentation of a persistent transaction interface according to embodiments. Referring now to FIG. 7A, operation 602 may include operation 702 depicting facilitating presentation of a persistent transaction interface of a device. For example, FIG. 3, e.g., FIG. 3A shows abiding device-based interchange presentation using a device as a medium for presentation facilitating module 302 facilitating presentation (e.g., issuing an instruction to a device display controller) of a persistent transaction interface (e.g., a soft button displayed at the top right corner of a touchscreen of the device) of a device (e.g., a tablet device).

Referring again to FIG. 7A, operation 702 may include operation 704 depicting facilitating presentation of a persistent transaction interface of the device, said device associated with at least one client. For example, FIG. 3, e.g., FIG. 3A, shows abiding device-based interchange presentation using a device associated with a client as a medium for presentation facilitating module 304 facilitating presentation of a persistent transaction interface (e.g., a microphone listening for a particular word) of the device (e.g., a smartphone device), said device associated with at least one client (e.g., said device carried by a user that owns the device).

Referring again to FIG. 7A, operation 704 may include operation 706 depicting displaying a persistent transaction interface on a screen of the device, said device associated with at least one client. For example, FIG. 3, e.g., FIG. 3A, shows abiding device-based interchange displaying using a projection device associated with a client as a medium for presentation facilitating module 306 displaying (e.g., causing a visible manifestation to appear to a client) a persistent transaction interface (e.g., a button that changes colors depending on status) on a screen of the device (e.g., a user's smartphone), said device associated with (e.g., purchased by, but not carried by) at least one client (e.g., a user who wishes to engage in one or more transactions).

Referring again to FIG. 7A, operation 706 may include operation 708 depicting displaying a button on a screen of the device, said device associated with at least one client. For example, FIG. 3, e.g., FIG. 3A, shows abiding device-based selectable switch displaying using a projection device associated with a client as a medium for presentation facilitating module 308 displaying a button on a screen of the device (e.g., a laptop computer), said device associated with (e.g., the client has logged into the device at least once) at least one client (e.g., a user of the laptop).

Referring again to FIG. 7A, operation 708 may include operation 710 depicting displaying a button designated as a transaction executing button on a screen of the device, said device associated with at least one client. For example, FIG. 3, e.g., FIG. 3A, shows abiding device-based transaction initiating switch displaying using a projection device associated with a client as a medium for presentation facilitating module 310 displaying a button designated as a transaction executing button on a screen of the device (e.g., a motor vehicle interactive controlling screen), said device associated with (e.g., located in a car in which the client is also located) at least one client (e.g., a passenger in the vehicle).

Referring again to FIG. 7A, operation 710 may include operation 712 depicting displaying a button designated as a transaction executing button on the screen of the device, said device associated with at least one client, and said button having a persistent characteristic. For example, FIG. 3, e.g., FIG. 3A, shows same parameter device-based transaction initiating switch displaying using a projection device associated with a client as a medium for presentation facilitating module 312 displaying a button designated as a transaction executing button on the screen of the device (e.g., a smart shopping cart with a display window), said device associated with at least one client (e.g., a shopper), and said button having a persistent characteristic (e.g., the button is always located on top of whatever else is being displayed (price, store map, etc.), and has a particular size and color (e.g., 70 pixels by 70 pixels, and green).

Referring again to FIG. 7A, operation 712 may include operation 714 depicting displaying the button designated as the transaction executing button on the screen of the device, said device associated with the at least one client, and said button being located in a same position on the screen of the device when the device is powered on. For example, FIG. 3, e.g., FIG. 3A, shows transaction initiating switch disposed at a same location with a same parameter under one or more particular device conditions displaying using a projection device associated with a client as a medium for presentation facilitating module 314 displaying the button designated as the transaction executing button on the screen of the device (e.g., a user's tablet device), said device associated (e.g., the device stores at least one piece of data about the client) with the at least one client (e.g., a purchaser of goods), said button being located in a same position (e.g., within five pixels in any direction) on the screen of the device when the device is powered on.

Referring now to FIG. 7B, operation 602 may include operation 716 depicting facilitating presentation of a transaction interface configured to provide a same option for interacting with the interface independently of one or more vendor payment channels used by the vendor. For example, FIG. 3, e.g., FIG. 3B, shows abiding device-based interchange presentation with a same characteristic independently of one or more vendor payment channels of the vendor payment channel set facilitating module 316 facilitating presentation of a transaction interface (e.g., a rocker switch) configured to provide a same option for interacting with the interface (e.g., flipping the rocker switch to pay for a coffee) independently of one or more vendor payment channels (e.g., credit card, debit card, store credit, frequent shopper points, PayPal) used by the vendor (e.g., a coffee shop).

Referring again to FIG. 7B, operation 602 may include operation 718 depicting facilitating presentation of a transaction interface configured to provide a same option for interacting with the interface when the potential transaction uses a first vendor payment channel and when the potential transaction uses a second vendor payment channel. For example, FIG. 3, e.g., FIG. 3B, shows abiding device-based interchange presentation with a same characteristic independently of a first vendor payment channel of the vendor payment channel set and a second vendor payment channel facilitating module 318 facilitating presentation of a transaction interface (e.g., making a particular gesture with the hands that is picked up and interpreted by a wearable device) configured to provide a same option for interacting with the interface when the potential transaction uses a first vendor payment channel (e.g., near-field communication as a payment modality and credit card with PIN as a payment option) and when the potential transaction uses a second vendor payment channel (e.g., encrypted Wi-Fi network as a payment modality).

Referring again to FIG. 7B, operation 602 may include operation 720 depicting facilitating presentation of a transaction interface configured to provide a same option for interacting with the interface independently of one or more client payment channels to be used in the potential transaction. For example, FIG. 3, e.g., FIG. 3B, shows abiding device-based interchange presentation with a same characteristic independently of one or more user payment channels facilitating module 320 facilitating presentation of a transaction interface configured to provide a same option for interacting with the interface independently of one or more client payment channels (e.g., whether to use credit card A or credit card B as a payment option, or to transfer the data over a wireless network, or through an optical beam as a payment modality) to be used in the potential transaction).

Referring again to FIG. 7B, operation 720 may include operation 722 depicting facilitating presentation of a transaction interface configured to provide a same option for interacting with the interface when the potential transaction uses a first client payment channel and when the potential transaction uses a second client payment channel. For example, FIG. 3, e.g., FIG. 3B, shows abiding device-based interchange presentation with a same characteristic independently of a first client payment channel and a second client payment channel facilitating module 322 facilitating presentation of a transaction interface (e.g., projection of an augmented reality button using a wearable headset) configured to provide a same option for interacting with the interface (e.g., eyes focusing on the projected button for more than four seconds) when the potential transaction (e.g., ordering a popcorn at a baseball game) uses a first client payment channel (e.g., retrieving credit card information that was used to purchase the ticket to identify the seat the user is sitting in to pass that data to the vendor) and when the potential transaction uses a second client payment channel (e.g., using a GPS sensor to identify the seat the user is sitting in to pass that data to the vendor).

Referring now to FIG. 7C, operation 602 may include operation 724 depicting facilitating a display of a persistent button on a screen of a device. For example, FIG. 3, e.g., FIG. 3C, shows abiding device-based interchange visual display facilitating module 324 facilitating a display of a persistent button on a screen of a device (e.g., a tablet device).

Referring again to FIG. 7C, operation 724 may include operation 726 depicting facilitating a display of a persistent button on a screen of the device that maintains one or more same display characteristics. For example, FIG. 3, e.g., FIG. 3C, shows abiding device-based interchange visual display having an abiding property facilitating module 326 facilitating a display of a persistent button on a screen of the device (e.g., a video game controller that has the button for in-game purchases) that maintains one or more same display characteristics (e.g., the button has the same color, shape, and location).

Referring again to FIG. 7C, operation 726 may include operation 728 depicting facilitating a display of a persistent button on a screen of the device that maintains a same position on the screen. For example, FIG. 3, e.g., FIG. 3C, shows abiding device-based interchange visual display having an abiding relative display position property facilitating module 328 facilitating a display of a persistent button on a screen of the device (e.g., here, device includes the video game controller and the television on which the video game is projected) that maintains a same position on the screen (e.g., of the television set).

Referring again to FIG. 7C, operation 726 may include operation 730 depicting facilitating a display of a persistent button on a screen of the device that maintains one or more of a same size, color, and orientation, independently of one or more other applications configured to control the screen of the device. For example, FIG. 3, e.g., FIG. 3C, shows abiding device-based interchange visual display having an abiding visual property facilitating module 330 facilitating a display of a persistent button on a screen of the device (e.g., a smartphone device) that maintains one or more of a same size, color, and orientation, independently of one or more other applications (e.g., a phone dialing application) configured to control the screen of the device (e.g., the persistent payment button still shows up in the bottom-left of the device screen, even when the device is making a phone call or surfing the internet).

Referring again to FIG. 7C, operation 726 may include operation 732 depicting intercepting one or more instructions from one or more other applications that are configured to alter one or more elements displayed on the screen of the device at the location of the persistent button. For example, FIG. 3, e.g., FIG. 3C, shows one or more instructions overriding the abiding device-based interchange visual display interrupting module 332 intercepting one or more instructions from one or more other applications (e.g., a map application) that are configured to alter one or more elements displayed on the screen (e.g., the pixels at the bottom left) of the device (e.g., the GPS navigational system and fuel purchasing assistant device) at the location of the persistent button (e.g., bottom left).

Referring again to FIG. 7C, operation 732 may include operation 734 depicting changing one or more instructions from one or more other applications that attempt to display an element on the screen of the device at a location of the persistent button, to display the element on the screen of the device at a different location. For example, FIG. 3, e.g., FIG. 3C, shows one or more instructions overriding the abiding device-based interchange visual display modifying module 334 changing one or more instructions (e.g., to display at a different location) from one or more other applications (e.g., a web browser) that attempt to display an element (e.g., the window of a web browser) on the screen of the device (e.g., a tablet device) at a location of the persistent button, to display the element on the screen (e.g., the web browser) of the device at a different location (e.g., one that does not cover the persistent payment button).

Referring now to FIG. 7D, operation 602 may include operation 736 depicting configuring a persistent transaction interface of a device to trigger facilitation of the potential transaction. For example, FIG. 3, e.g., FIG. 3D, shows abiding device-based interchange presentation that is configured to initiate at least a portion of a potential transaction facilitating module 336 configuring a persistent transaction interface of a device (e.g., a store-owned handheld device that is given to a user when a user enters a department store) to trigger (e.g., facilitate a starting of) facilitation of the potential transaction (e.g., paying for a coffee at a coffee shop from your seat, without having to go to the register).

Referring again to FIG. 7D, operation 736 may include operation 738 depicting configuring a pressable button of the device to trigger facilitation of the potential transaction. For example, FIG. 3, e.g., FIG. 3D, shows abiding dual-state device-based interchange presentation that is configured to initiate at least a portion of a potential transaction facilitating module 338 configuring a pressable button of the device (e.g., a pager device with a single button that is handed to you when you enter a bar, and is designed to be cheaply made so if it is not returned, the business has not lost too much value) to trigger facilitation of the potential transaction (e.g., paying for a drink, so you don't have to hand money to the bartender or keep your credit card on file with her).

Referring again to FIG. 7D, operation 736 may include operation 740 depicting configuring a pressable button of a device that is configured to be supplied to a user by a vendor, to trigger facilitation of the potential transaction between the user and the vendor when the user presses the button. For example, FIG. 3, e.g., FIG. 3D, shows abiding dual-state vendor-provided device-based interchange presentation that is configured to initiate at least a portion of a potential transaction facilitating module 340 configuring a pressable button of a device that is configured to be supplied to a user by a vendor (e.g., a smart shopping cart that the user picks up when they enter the grocery store), to trigger facilitation of a transaction between the user and the vendor (e.g., calculating an estimated price of the goods that are currently in the user's shopping cart) when the user presses the button (e.g., which is located on a handle of the shopping cart).

Referring again to FIG. 7D, operation 602 may include operation 742 depicting facilitating presentation of one or more alterations of a perception of a reality through mediated reality that form a persistent transaction interface. For example, FIG. 3, e.g., FIG. 3D, shows abiding device-based interchange presentation at least partially using mixed-reality facilitating module 342 facilitating presentation of one or more alterations of a perception of a reality (e.g., having a virtual checkout line displayed with a virtual checkout button) through mediated reality (e.g., projection through wearable glasses) that form a persistent transaction interface (e.g., a floating button).

Referring again to FIG. 7D, operation 742 may include operation 744 depicting facilitating presentation of one or more portions of a scene through augmented reality, said one or more portions of the scene forming the persistent transaction interface. For example, FIG. 3, e.g., FIG. 3D, shows abiding device-based interchange presentation at least partially using an augmentation in a mixed-reality facilitating module 344 facilitating presentation of one or more portions (e.g., a checkout “lever” that appears at a client's table when the client is sitting at a coffee shop) of a scene through augmented reality, said one or more portions of a scene (e.g., the scene including the real elements, e.g., the table, and the virtual elements, e.g., the checkout lever displayed on the table), said one or more portions of the scene forming a persistent transaction interface (e.g., the projection of the checkout lever.

Referring again to FIG. 7D, operation 744 may include operation 746 depicting facilitating presentation of a three-dimensional interactive button that interacts with an augmented reality environment of a client, said interactive button forming the persistent transaction interface. For example, FIG. 3, e.g., FIG. 3D, shows abiding device-based interchange presentation at least partially using a mixed-reality multi-state switch facilitating module 346 facilitating presentation of a three-dimensional interactive button that interacts with an augmented reality environment (e.g., through an augmented reality car windshield) of a user (e.g., a driver), said interactive button forming a persistent transaction interface (e.g., the button looks the same whether the driver stops for gas at Gas Station A, which only takes Visa and requires entry of the billing zip code, and Gas Station B, which only takes debit cards and requires entry of a PIN).

Referring again to FIG. 7D, operation 744 may include operation 748 depicting facilitating presentation of a heads-up display that appears in an augmented reality environment of a client, said heads up display forming the persistent transaction interface. For example, FIG. 3, e.g., FIG. 3D, shows abiding device-based interchange presentation at least partially using a virtual heads-up display facilitating module 348 facilitating presentation of a heads-up display (e.g., a display that appears on the periphery and/or main focus of a client's view, regardless of what the client is looking at) that appears in an augmented reality environment of a user, said heads up display forming a persistent transaction interface (e.g., in a grocery store, the “buy now” augmented reality button is always there, and displays the total cost inside the confines of the button, regardless of which item the user is looking at).

Referring now to FIG. 7E, operation 602 may include operation 750 depicting facilitating presentation of the persistent transaction interface that is configured to receive as input one or more gesticulations. For example, FIG. 3, e.g., FIG. 3E, shows abiding device-based interchange presentation configured to receive articulated gesture input facilitating module 350 facilitating presentation of a persistent transaction interface (e.g., an interface for something wearable, e.g., a watch) that is configured to receive as input one or more gesticulations (e.g., a particular hand movement, e.g., five concentric circles, causes a triggering of a transaction to check out and pay for purchases at the store).

Referring again to FIG. 7E, operation 750 may include operation 752 depicting facilitating presentation of the persistent transaction interface that is configured to receive as input a particular motion of a hand. For example, FIG. 3, e.g., FIG. 3E, shows abiding device-based interchange presentation configured to receive one or more extremity movements as input facilitating module 352 facilitating presentation of a persistent transaction interface (e.g., an accelerometer of a smart watch) that is configured to receive as input a particular motion of a hand (e.g., raising the hand over the head five times within a particular time window).

Referring again to FIG. 7E, operation 750 may include operation 754 depicting facilitating presentation of the persistent transaction interface that is configured to receive as input a particular retinal motion. For example, FIG. 3, e.g., FIG. 3E, shows abiding device-based interchange presentation configured to receive one or more eye movements as input facilitating module 354 facilitating presentation of a persistent transaction interface (e.g., a projection from a pocket projector) that is configured to receive as input a particular retinal motion (e.g., measured by a different device, e.g., glasses, that communicates with the pocket projector).

Referring now to FIG. 7F, operation 602 may include operation 756 depicting facilitating presentation of the persistent transaction interface at a device configured to assist in carrying out one or more transactions. For example, FIG. 3, e.g., FIG. 3F, shows abiding device-based interchange presentation facilitating at a device configured to carry out at least a portion of one or transactions module 356 facilitating presentation of a persistent transaction interface (e.g., a headset that can be spoken to) at a device (e.g., a gaming headset) configured to assist in carrying out one or more transactions (e.g., buying one or more in-game items, or interacting with a shopping interface for physical goods during loading times for one or more games) configured to assist in carrying out one or more transactions (e.g., to take orders).

Referring again to FIG. 7F, operation 756 may include operation 758 depicting facilitating presentation of the persistent transaction interface at a grocery shopping cart. For example, FIG. 3, e.g., FIG. 3F, shows abiding device-based interchange presentation facilitating at a shopping cart module 358 facilitating presentation of the persistent transaction interface (e.g., a simple button with a wireless radio attached to a shopping cart) at a grocery shopping cart.

Referring again to FIG. 7F, operation 756 may include operation 760 depicting facilitating presentation of the persistent transaction interface at a cash register. For example, FIG. 3, e.g., FIG. 3F, shows abiding device-based interchange presentation facilitating at a cash register module 360 facilitating presentation of the persistent transaction interface (e.g., a touchscreen with a persistent button) at a cash register.

Referring again to FIG. 7F, operation 756 may include operation 762 depicting facilitating presentation of the persistent transaction interface at a gasoline pump. For example, FIG. 3, e.g., FIG. 3F, shows abiding device-based interchange presentation facilitating at an automated teller machine module 362 facilitating presentation of the persistent transaction interface (e.g., a virtual gas station attendant that responds to a horn honk) at a gasoline pump.

Referring again to FIG. 7F, operation 756 may include operation 764 depicting facilitating presentation of a persistent transaction interface within a movie theater seat. For example, FIG. 3, e.g., FIG. 3F, shows abiding device-based interchange presentation facilitating at a movie theater seating device module 364 facilitating presentation of a persistent transaction interface (e.g., a seat button, e.g., similar to a seat reclining button of an airplane) within a movie theater seat.

FIGS. 8A-8C depict various implementations of operation 604, depicting determining a vendor payment channel set for facilitating a potential transaction that corresponds to the presentation of the persistent transaction interface, according to embodiments. Referring now to FIG. 8A, operation 604 may include operation 802 depicting determining a vendor payment channel set that is configured to be used for facilitating a potential transaction in response to receipt of a signal, from a device interface controller, that the persistent transaction interface of the device has been activated. For example, FIG. 4, e.g., FIG. 4A, shows vendor payment channel set related to a potential transaction that is configured to be triggered by receipt of an internal signal received from the abiding device-based interchange acquiring module 402 determining a vendor payment channel set that is configured to be used for facilitating a potential transaction (e.g., a purchase of a Matt & Kim compact disc at a music store) in response to receipt of a signal (e.g., an internal voltage signal indicating that a touchscreen button has been pressed), from a device interface controller (e.g., device interface controller 228C of FIG. 2B), that the persistent transaction interface of the device has been activated.

Referring again to FIG. 8A, operation 802 may include operation 804 depicting determining one or more of at least one vendor payment modality and at least one vendor payment option configured to be used for facilitating a potential transaction upon receipt of a signal, from a device interface controller, that the persistent transaction interface of the device has been activated. For example, FIG. 4, e.g., FIG. 4A, shows vendor payment channel set including one or more of at least one vendor payment modality and at least one vendor payment option related to a potential transaction that is configured to be triggered by receipt of an internal signal received from the abiding device-based interchange acquiring module 404 determining (e.g., receiving from the vendor) one or more of at least one vendor payment modality (e.g., credit card verification using swipe only) and at least one vendor payment option (e.g., a fuel rewards card) configured to be used for facilitating a potential transaction (e.g., purchasing gasoline) upon receipt of a signal, from a device interface controller (e.g., a motor vehicle control system), that the persistent transaction interface of the device (e.g., a button on the motor vehicle steering wheel) has been activated.

Referring again to FIG. 8A, operation 804 may include operation 806 depicting determining one or more of at least one vendor payment modality including near-field communication with device tap and at least one vendor payment option including bank debit card with personal identification number data transmission configured to be used for facilitating a potential transaction upon receipt of a signal, from the device interface controller, that a persistent soft key of the device has been activated. For example, FIG. 4, e.g., FIG. 4A, shows vendor payment channel set including one or more of at least one vendor payment modality including a near-field communication modality and at least one vendor payment option including a bank card option related to a potential transaction that is configured to be triggered by receipt of an internal signal received from the abiding device-based interchange acquiring module 406 determining one or more of at least one vendor payment modality including near-field communication with device tap and at least one vendor payment option including bank debit card with personal identification number data transmission configured to be used for facilitating a potential transaction upon receipt of a signal, from the device interface controller, that a persistent soft key of the device has been activated.

Referring again to FIG. 8A, operation 806 may include operation 808 depicting determining one or more of at least one vendor payment modality including near-field communication with device tap and at least one vendor payment option including bank debit card with personal identification number data transmission configured to be used for facilitating a potential transaction upon receipt of a signal, from the device interface controller, that a persistent soft key of a smartphone device has been activated. For example, FIG. 4, e.g., FIG. 4A, shows vendor payment channel set including one or more of at least one vendor payment modality including a near-field communication modality and at least one vendor payment option including a bank card option related to a potential transaction that is configured to be triggered by receipt of an internal signal received from a soft key of the abiding device-based interchange acquiring module 408 determining one or more of at least one vendor payment modality including near-field communication with device tap and at least one vendor payment option including bank debit card with personal identification number data transmission configured to be used for facilitating a potential transaction upon receipt of a signal, from the device interface controller, that a persistent soft key of a smartphone device has been activated.

Referring again to FIG. 8A, operation 806 may include operation 810 depicting determining one or more of at least one vendor payment modality including near-field communication with device tap and at least one vendor payment option including bank debit card with personal identification number data transmission configured to be used for facilitating a potential transaction for ordering a coffee drink upon receipt of a signal, from the device interface controller, that a persistent soft key of a device owned by a coffee vendor and handed to a user has been activated. For example, FIG. 4, e.g., FIG. 4A, shows vendor payment channel set including one or more of at least one vendor payment modality including a near-field communication modality and at least one vendor payment option including a bank card option related to a potential transaction that is configured to be triggered by receipt of an internal signal received from a soft key of the abiding vendor-provided device-based interchange acquiring module 410 determining one or more of at least one vendor payment modality including near-field communication with device tap and at least one vendor payment option including bank debit card with personal identification number data transmission configured to be used for facilitating a potential transaction for ordering a coffee drink upon receipt of a signal, from the device interface controller, that a persistent soft key of a device owned by a coffee vendor and handed to a user has been activated.

Referring now to FIG. 8B, operation 604 may include operation 812 depicting determining a vendor payment channel set for facilitating a potential transaction upon displaying a persistent transaction interface. For example, FIG. 4, e.g., FIG. 4B, shows vendor payment channel set related to a potential transaction determining upon generation of the abiding device-based interchange module 412 determining a vendor payment channel set (e.g., one vendor payment option and one vendor payment channel, e.g., credit card alpha and credit card verification with swipe only) for facilitating a potential transaction (e.g., buying groceries at a grocery store) upon displaying a persistent transaction interface (e.g., a hard button on a device provided by the vendor, e.g., the grocery store).

Referring again to FIG. 8B, operation 812 may include operation 814 depicting determining a vendor payment channel set including one or more of at least one vendor payment modality and at least one vendor payment option facilitating a potential transaction upon displaying a persistent transaction interface in a modified reality scene. For example, FIG. 4, e.g., FIG. 4B, shows vendor payment channel set including one or more of at least one vendor payment modality and at least one vendor payment option related to a potential transaction determining upon generation of a mixed-reality abiding device-based interchange module 414 determining a vendor payment channel set (e.g., two vendor payment options (e.g., store credit card, fuel rewards card) and two vendor payment modalities, (e.g., credit card verification with signature and color barcode)) including one or more of at least one vendor payment modality (e.g., store credit card) and at least one vendor payment option (e.g., color barcode) for facilitating a potential transaction (e.g., purchasing a television at a big-box electronics store) upon displaying a persistent transaction interface (e.g., a floating 3-d button) in a modified reality scene.

Referring again to FIG. 8B, operation 604 may include operation 816 depicting determining a vendor payment channel set for facilitating a potential transaction prior to facilitating the presentation of the persistent transaction interface. For example, FIG. 4, e.g., FIG. 4B, shows vendor payment channel set related to a potential transaction that is configured to be determined prior to facilitating presentation of the abiding device-based interchange acquiring module 416 determining a vendor payment channel set (e.g., speech recognition, voice recognition, device proxy, password only, trusted device voucher, quick response code for facilitating a potential transaction) for facilitating a potential transaction (e.g., paying for dinner at a restaurant) prior to facilitating the presentation of the persistent transaction interface (e.g., prior to displaying, on the user's smartphone, the persistent “pay” button, which is the same regardless of what credit cards the vendor accepts, and what credit card the user is electing to pay with).

Referring again to FIG. 8B, operation 604 may include operation 818 depicting determining a vendor payment channel set for facilitating a potential transaction. For example, FIG. 4, e.g., FIG. 4B, shows vendor payment channel set configured to facilitate a potential transaction determining module 418 determining a vendor payment channel set (e.g., two vendor payment options (e.g., frequent shopper rewards card, nonspecific gift certificate) and two vendor payment modalities (e.g., card-embedded microchip, virtual currency transaction) for facilitating a potential transaction (e.g., purchasing cigars at a cigar shop).

Referring again to FIG. 8B, operation 604 may include operation 820 depicting facilitating the presentation of the persistent transaction interface after determination of the vendor payment channel set. For example, FIG. 4, e.g., FIG. 4B, shows abiding device-based interchange presentation facilitating after determination of vendor payment channel set 420 facilitating the presentation of the persistent transaction interface (e.g., a button that maintains a same position on a device screen) after determination of the vendor payment channel set (e.g., a vendor payment option set (e.g., corporate credit card, PayPal account, frequent shopper rewards card) and a vendor payment modality set (e.g., speech recognition, voice recognition, device proxy, password only, trusted device voucher, quick response code)).

Referring again to FIG. 8B, operation 820 may include operation 822 depicting obscuring the presentation of the persistent transaction interface until the determination of the vendor payment channel set has occurred. For example, FIG. 4, e.g., FIG. 4B, shows abiding device-based interchange presentation deobscuring upon determination of vendor payment channel set 422 obscuring (e.g., changing one or more features of, in order to discourage or disable activation, e.g., “graying out” a button, or causing the button to flash red) the presentation (e.g., display) of the persistent transaction interface (e.g., a constant-positioned button) until the determination of the vendor payment channel (e.g., a vendor payment option (e.g., the frequent shopper rewards card)).

Referring again to FIG. 8B, operation 822 may include operation 824 depicting changing a presentation characteristic of the persistent transaction interface until the determination of the vendor payment channel set has occurred. For example, FIG. 4, e.g., FIG. 4B, shows abiding device-based interchange presentation deobscuring by restoring a presentation characteristic of the abiding device-based interchange upon determination of vendor payment channel set 424 changing a presentation characteristic (e.g., size of a switch) of the persistent transaction interface (e.g., a knob, e.g., that looks like a volume knob of an amplifier, displayed on a screen) until the determination of the vendor payment channel set (e.g., foreign currency, BitCoins, travelers check, bearer bonds, and quick response code, one-dimensional bar code, color barcode, card-embedded microchip, virtual currency transaction) has occurred.

Referring again to FIG. 8B, operation 820 may include operation 826 depicting preventing the presentation of the persistent transaction interface until the determination of the vendor payment channel set has occurred. For example, FIG. 4, e.g., FIG. 4B, shows abiding device-based interchange presentation presenting only upon determination of vendor payment channel set 426 preventing the presentation of the persistent transaction interface (e.g., a three-dimensional button displayed in front of the user in an augmented reality setting) until the determination of the vendor payment channel set has occurred (e.g., when the button appears, the user knows the vendor payment channel set has been determined, and the transaction can be completed).

Referring now to FIG. 8C, operation 604 may include operation 828 depicting determining a vendor payment channel set for facilitating a potential transaction. For example, FIG. 4, e.g., FIG. 4C, shows vendor payment channel set that is configured to facilitate a potential transaction determining module 428 determining a vendor payment channel set (e.g., two vendor payment options and two vendor payment modalities) for facilitating a potential transaction (e.g., paying for groceries at a grocery store).

Referring again to FIG. 8C, operation 604 may include operation 830 depicting facilitating the presentation of the persistent transaction interface that is configured to use at least one vendor payment channel of the vendor payment channel set for facilitating the potential transaction. For example, FIG. 4, e.g., FIG. 4C, shows abiding device-based interchange that is configured to use at least one vendor payment channel of the vendor payment channel presentation handling module 430 facilitating the presentation of the persistent transaction interface (e.g., a three-dimensional button displayed as part of a heads up display of an augmented reality environment for a person wearing specialized glasses) that is configured to use at least one vendor payment channel (e.g., credit card tap) of the vendor payment channel set (e.g., five vendor payment modalities and no specified vendor payment options, e.g., credit card tap, credit card verification with swipe only, credit card verification with personal identification number (“PIN”) entry, credit card verification with signature, and one-dimensional bar code) for facilitating the potential transaction (e.g., buying popcorn at a baseball game).

Referring again to FIG. 8C, operation 830 may include operation 832 depicting preventing the presentation of the persistent transaction interface when said determining a vendor payment channel set results in an empty set. For example, FIG. 4, e.g., FIG. 4C, shows abiding device-based interchange that is configured to use at least one vendor payment channel of the vendor payment channel presentation handling to prevent presentation when the vendor payment channel set is an empty set module 432 preventing the presentation of the persistent transaction interface (e.g., locking a physical button so that it cannot be pressed, e.g., by extending a lever that prevents the pushing of the button, or by disconnecting the button, or by instructing a device controller to ignore the button press) of the persistent transaction interface (e.g., a button on a device provided by a vendor when the user enters the vendor's store) when said determining a vendor payment channel set results in an empty set (e.g., for this user, under these circumstances, there is no acceptable vendor payment channel set, e.g., this may also come about temporarily, e.g., if the vendor payment system is down or not accepting new orders or is overloaded, for example).

Referring again to FIG. 8C, operation 604 may include operation 834 depicting determining a vendor payment channel set for facilitating a potential transaction that corresponds to the presentation of the persistent transaction interface, said persistent transaction interface hiding the determined vendor payment channel set from an entity interacting with the persistent transaction interface. For example, FIG. 4, e.g., FIG. 4C, shows vendor payment channel set related to a potential transaction that is configured to be triggered by interaction with the abiding device-based interchange that obscures the vendor payment channel set acquiring module 434 determining a vendor payment channel set for facilitating a potential transaction (e.g., purchasing concessions at a movie theater) that corresponds to (e.g., activating the persistent transaction interface causes the vendor payment channel set to be used) of the persistent transaction interface (e.g., a button that pops up on a user's smartphone when the user plugs the smartphone into his movie theater seat, or when the user sits down in the movie theater seat and the device recognizes the seat through one or more techniques, e.g., GPS or computer vision), said persistent transaction interface hiding (e.g., preventing from viewing easily or directly, or in some embodiments, from viewing it at all) the determined vendor payment channel set from an entity interacting with (e.g., the user) the persistent transaction interface (e.g., the button on the user's smartphone.

Referring again to FIG. 8C, operation 604 may include operation 836 depicting determining a vendor payment channel set including a single vendor payment channel for facilitating a potential transaction that corresponds to the presentation of the persistent transaction interface. For example, FIG. 4, e.g., FIG. 4C, shows vendor payment channel set having a single vendor payment channel related to a potential transaction that is configured to be triggered by interaction with the abiding device-based interchange acquiring module 436 determining a vendor payment channel set including a single vendor payment channel (e.g., one vendor payment option, e.g., credit card alpha, and one vendor payment modality, e.g., credit card verification with signature) for facilitating a potential transaction (e.g., purchasing items in-game for use in a video game) that corresponds to the presentation of the persistent transaction interface (e.g., a button that pops up on the screen of a video game when a transaction is available).

Referring again to FIG. 8C, operation 836 may include operation 838 depicting determining a vendor payment channel set including a single vendor payment channel, including a single vendor payment option, for facilitating a potential transaction that corresponds to the presentation of the persistent transaction interface. For example, FIG. 4, e.g., FIG. 4C, shows vendor payment channel set having a single vendor payment channel having a single vendor payment modality related to a potential transaction that is configured to be triggered by interaction with the abiding device-based interchange acquiring module 438 determining a vendor payment channel set (e.g., paying via an online currency exchange, e.g., BitCoin, as a vendor payment option), including a single vendor payment option, for facilitating a potential transaction that corresponds to the presentation of the persistent transaction interface (e.g., a button in the top-right of whatever window is currently active on a laptop computer running Windows 8).

FIGS. 9A-9Q depict various implementations of operation 606 depicting determining one or more resources configured to be used to carry out at least a portion of the potential transaction using at least one vendor payment channel from the determined at least one vendor payment channel set, according to embodiments. Referring now to FIG. 9A, operation 606 may include operation 902 depicting determining one or more data tables configured to be used to carry out at least portion of the potential transaction using at least one vendor payment channel from the determined at least one vendor payment channel set. For example, FIG. 5, e.g., FIG. 5A, shows one or more databases related to carrying out at least a portion of the potential transaction using the acquired vendor payment channel set locating module 502 determining one or more data tables (e.g., tables including data, e.g., data that will convert a picture of an item taken by a camera of a user's smartphone into a product code accepted by the vendor) configured to be used to carry out at least a portion (e.g., item for purchase identification) of the potential transaction using at least one vendor payment channel (e.g., vendor product codes) from the determined at least one vendor payment channel set (e.g., a set including vendor product codes, manufacturer product codes, and the like).

Referring again to FIG. 9A, operation 606 may include operation 904 depicting determining a product code conversion table configured to be used to carry out at least a portion of the potential transaction using the at least one vendor payment channel. For example, FIG. 5, e.g., FIG. 5A, shows one or more vendor-specific data translation tables related to carrying out at least a portion of the potential transaction using the acquired vendor payment channel set locating module 504 determining a product code conversion table (e.g., a conversion table that translates bar codes stamped on a product for sale into vendor codes accepted by the vendor) configured to be used to carry out at least a portion (e.g., a price checking portion) of the potential transaction (e.g., buying a television) using the at least one vendor payment channel (e.g., vendor product codes as a part of a vendor payment option and transmission of vendor codes as part of a vendor payment modality).

Referring again to FIG. 9A, operation 606 may include operation 906 depicting retrieving the product code conversion table configured to be used to carry out at least a portion of the transaction using the at least one vendor payment channel. For example, FIG. 5, e.g., FIG. 5A, shows located one or more vendor-specific data translation tables retrieving module 506 retrieving the product code conversion table (e.g., from the vendor) configured to be used to carry out at least a portion of the transaction using the at least one vendor payment channel (e.g., vendor product codes as a part of a vendor payment option and transmission of vendor codes as part of a vendor payment modality).

Referring again to FIG. 9A, operation 606 may include operation 908 depicting determining a location of one or more information resources containing data related to at least one vendor payment channel from the vendor payment channel set. For example, FIG. 5, e.g., FIG. 5A, shows one or more resource addresses related to carrying out at least a portion of the potential transaction using the acquired vendor payment channel set determining module 508 determining a location of one or more information resources (e.g., access to a listing of credit cards accepted by the vendor and what sort of security measures one requires) containing data related to at least one vendor payment channel (e.g., accepting credit cards with swipe only, no additional authentication required, as a vendor payment modality) from the vendor payment channel set (e.g., a set that includes accepting credit cards with swipe only, and accepting credit cards with swipe and zip code entry as a set of vendor payment modalities, and credit card alpha and credit card beta as vendor payment options).

Referring again to FIG. 9A, operation 908 may include operation 910 depicting determining a location of one or more credit card databases containing data related to at least one vendor payment channel from the vendor payment channel set. For example, FIG. 5, e.g., FIG. 5A, shows one or more credit card data storage addresses related to carrying out at least a portion of the potential transaction using the acquired vendor payment channel set determining module 510 determining a location of one or more credit card databases containing data (e.g., authentication codes) related to at least one vendor payment channel (e.g., the vendor payment channel requires authentication code with credit card, but it is not stored on the user's device, so the credit card database is contacted) from the vendor payment channel set.

Referring now to FIG. 9B, operation 606 may include operation 912 depicting determining one or more resources configured to be used to convert data into a format used by at least one vendor payment channel from the determined at least one vendor payment channel set. For example, FIG. 5, e.g., FIG. 5B, shows one or more resources related to carrying out at least a portion of the potential transaction using the acquired vendor payment channel set and configured to transform transaction data for use by at least one vendor payment channel of the vendor payment channel set locating module 512 determining one or more resources configured to be used to convert data into a format (e.g., conversion of unencrypted data into 256-bit AES encrypted data) used by at least one vendor payment channel (e.g., for certain types of online payment, the vendor requires 256-bit AES encryption as a payment modality for online payment transfers) from the determined at least one vendor payment channel set (e.g., a set that includes types of online payment as vendor payment options and security requirements for each payment option as vendor payment modalities).

Referring again to FIG. 9B, operation 912 may include operation 914 depicting determining one or more resources configured to be used to convert data stored on a device configured to present the persistent transaction interface into the format used by the at least one vendor payment channel from the determined at least one vendor payment channel set. For example, FIG. 5, e.g., FIG. 5B, shows one or more resources related to carrying out at least a portion of the potential transaction using the acquired vendor payment channel set and configured to transform transaction data for use by at least one vendor payment channel of the vendor payment channel set locating on a device configured to present the abiding device-based interface module 514 determining one or more resources configured to be used to convert data stored on a device (e.g., data for accessing an online payment account, e.g., a PayPal account) configured to present the persistent transaction interface (e.g., a button on a touchscreen of a tablet device) into the format used by the at least one vendor payment channel (e.g., the vendor payment channel requires direct bank account information, which the device retrieves from the PayPal account settings) from the determined at least one vendor payment channel set.

Referring again to FIG. 9B, operation 914 may include operation 916 depicting determining one or more resources configured to be used to convert user payment channel data stored on a device configured to present the persistent transaction interface into the format used by the at least one vendor payment channel from the determined at least one vendor payment channel set. For example, FIG. 5, e.g., FIG. 5B, shows one or more resources related to carrying out at least a portion of the potential transaction using the acquired vendor payment channel set and configured to transform client payment channel data for use by at least one vendor payment channel of the vendor payment channel set locating on a device configured to present the abiding device-based interface module 516 determining one or more resources (e.g., a central server for Wells Fargo bank to store its information about debit cards) configured to be used to convert user payment channel data (e.g., an account number for a Wells Fargo checking account) stored on a device (e.g., a user's laptop device) configured to present the persistent transaction interface (e.g., a programmable hard key at the top of the keyboard on the laptop computer) into the format used by the at least one vendor payment channel set (e.g., the vendor uses 16-digit credit card-type codes, not bank account codes) from the determined at least one vendor payment channel set.

Referring again to FIG. 9B, operation 916 may include operation 918 depicting determining one or more resources configured to be used to convert at least one user payment channel of a user payment channel set stored on the device configured to present the persistent transaction interface into the format used by the at least one vendor payment channel from the determined at least one vendor payment channel set. For example, FIG. 5, e.g., FIG. 5B, shows one or more resources related to carrying out at least a portion of the potential transaction using the acquired vendor payment channel set and configured to transform client payment channel data of a client payment channel set for use by at least one vendor payment channel of the vendor payment channel set locating on a device configured to present the abiding device-based interface module 518 determining one or more resources (e.g., an external device that has both near-field communication and a cellular network) configured to be used to convert at least one user payment channel (e.g., near-field communication as a user payment modality) of a user payment channel set stored on the device (e.g., a device that only has near-field communication) configured to present the persistent transaction interface (e.g., a button on the screen of the device) into the format used by the at least one vendor payment channel (e.g., a cellular network for communication, so the external device is close enough to user near-field communication to capture the necessary data from the user's device and transmit that data to the vendor using a cellular network) from the determined at least one vendor payment channel set.

Referring again to FIG. 9B, operation 916 may include operation 920 depicting determining one or more resources configured to be used to convert user payment channel data including one or more of a user payment option and a user payment modality, said user payment channel data stored on a device configured to present the persistent transaction interface into the format used by the at least one vendor payment channel from the determined at least one vendor payment channel set. For example, FIG. 5, e.g., FIG. 5B, shows one or more resources related to carrying out at least a portion of the potential transaction using the acquired vendor payment channel set and configured to transform client payment channel data of one or more of at least one client payment modality and at least one client payment option for use by at least one vendor payment channel of the vendor payment channel set locating on a device configured to present the abiding device-based interface module 520

Referring now to FIG. 9C, operation 606 may include operation 922 depicting determining one or more resources configured to be used to manipulate data into a result suitable for use by at least one vendor payment channel from the determined at least one vendor payment channel set. For example, FIG. 5, e.g., FIG. 5C, shows one or more resources related to carrying out at least a portion of the potential transaction using the acquired vendor payment channel set and configured to manipulate transaction data for use by at least one vendor payment channel of the vendor payment channel set locating module 522 determining one or more resources configured to be used to manipulate data (e.g., change, add to, subtract from, alter, process, and the like) into a result (e.g., new or modified data) suitable for use by at least one vendor payment channel (e.g., instant credit approval mechanism) from the determined at least one vendor payment channel set.

Referring again to FIG. 9C, operation 922 may include operation 924 depicting determining one or more external resources configured to be used to manipulate data into a result suitable for use by at least one vendor payment channel from the determined at least one vendor payment channel. For example, FIG. 5, e.g., FIG. 5C, shows one or more external resources related to carrying out at least a portion of the potential transaction using the acquired vendor payment channel set and configured to manipulate transaction data for use by at least one vendor payment channel of the vendor payment channel set locating module 524 determining or more external resources (e.g., a central server that maintains signature data for all the users that purchase a device sold by a particular manufacturer) configured to be used to manipulate data into a result (e.g., to add signature data to existing credit card data on the device) suitable for use by at least one vendor payment channel (e.g., a vendor payment modality that requires credit card swipe and signature) from the determined at least one vendor payment channel.

Referring again to FIG. 9C, operation 924 may include operation 926 depicting determining one or more external resources controlled by a manufacturer of one or more components of a device configured to present the persistent transaction interface, said one or more external resources configured to be used to manipulate data into a result suitable for use by at least one vendor payment channel from the determined at least one vendor payment channel. For example, FIG. 5, e.g., FIG. 5C, shows one or more external resources controlled by a device component provider and related to carrying out at least a portion of the potential transaction using the acquired vendor payment channel set and configured to manipulate transaction data for use by at least one vendor payment channel of the vendor payment channel set locating module 526 determining one or more external resources (e.g., a unique device identifier used to uniquely identify a device and a user for purposes of confirming their identity and social security number to receive an instant line of credit) controlled by a manufacturer of one or more components (e.g., hardware or software, including operating systems and/or applications, and hardware including specific chips, keyboards, or other accessories, and similar) of a device configured to present the persistent transaction interface (e.g., a device that has dedicated hardware to maintain a persistent payment button in the top right corner of a device), said one or more external resources configured to be used to manipulate data (e.g., verification of data and adding a stamp of verification to the data) into a result suitable for use by at least one vendor payment channel (e.g., instant credit approval upon identity verification) from the determined at least one vendor payment channel.

Referring again to FIG. 9C, operation 924 may include operation 928 depicting determining one or more external resources controlled by a provider of a communication network, said one or more external resources configured to be used to manipulate data into a result suitable for use by at least one vendor payment channel from the determined at least one vendor payment channel. For example, FIG. 5, e.g., FIG. 5C, shows one or more external resources controlled by a communication network provider and related to carrying out at least a portion of the potential transaction using the acquired vendor payment channel set and configured to manipulate transaction data for use by at least one vendor payment channel of the vendor payment channel set locating module 528 determining one or more external resources (e.g., providing an anonymizing network so that financial data can be transmitted without revealing more data than is necessary about the user) controlled by a provider of a communication network (e.g., a provider of a cellular network, e.g., AT&T), said one or more external resources (e.g., a traffic anonymizing resource) configured to be used to manipulate data (e.g., strip out identifying data and change data about an originating IP address, for example) into a result suitable for use by at least one vendor payment channel (e.g., a vendor payment channel that demands anonymity for purchases for either legal or security reasons) from the determined at least one vendor payment channel.

Referring again to FIG. 9C, operation 924 may include operation 930 depicting determining one or more external resources controlled by a vendor, said one or more external resources configured to be used to manipulate data into a result suitable for use by at least one vendor payment channel from the determined at least one vendor payment channel. For example, FIG. 5, e.g., FIG. 5C, shows one or more external resources controlled by a vendor and related to carrying out at least a portion of the potential transaction using the acquired vendor payment channel set and configured to manipulate transaction data for use by at least one vendor payment channel of the vendor payment channel set locating module 530 determining one or more external resources (e.g., a third party device that is located in a proximity to a user's device, e.g., a vendor device that communicates with devices and provides bar code data) controlled by a vendor (e.g., a vendor has a relationship with the device or knowledge about the device) and configured to be used to manipulate data (e.g., change the optical data into a bar code data that the vendor can accept) suitable for use by at least one vendor payment channel (e.g., barcode scanning as a payment modality) from the determined at least one vendor payment channel (e.g., including “two-dimensional barcode scanning”).

Referring again to FIG. 9C, operation 924 may include operation 932 depicting determining one or more external resources within a particular proximity to a vendor, said one or more external resources configured to be used manipulate data into a result suitable for use by at least one vendor payment channel from the determined at least one vendor payment channel. For example, FIG. 5, e.g., FIG. 5C, shows one or more external resources having a particular proximity to a vendor and related to carrying out at least a portion of the potential transaction using the acquired vendor payment channel set and configured to manipulate transaction data for use by at least one vendor payment channel of the vendor payment channel set locating module 532 determining one or more external resources (e.g., other cellular telephone devices) within a particular proximity to a vendor (e.g., within a storefront controlled by the vendor, e.g., inside a Best Buy electronics store), said one or more external resources (e.g., another user's cellular telephone device) configured to be used to manipulate data. For example, the other user's cellular telephone device is in the front of a line at a check-out counter, and in a near proximity with the checkout register to communicate with the checkout register using near-field communication, and the user carrying out the transaction wants to buy a television without waiting in line. Thus, the payment transaction data is relayed to the other user's device, and then sent using near-field communication to the checkout register, to allow the user to purchase the item without having to go up to the register. In an embodiment, this example can take place without the other user's knowledge. In another embodiment, the other user has signed up for a service that allows the system to use her device in such a manner. In another embodiment, the other user is compensated a small percentage of the transaction for using her device.

Referring now to FIG. 9D, operation 924 may include operation 934 depicting receiving a list of one or more external resources configured to be used to manipulate data into a result suitable for use by at least one vendor payment channel. For example, FIG. 5, e.g., FIG. 5D, shows list of one or more external resources configured to manipulate transaction data for use by at least one vendor payment channel of the vendor payment channel set acquiring module 534 receiving a list of one or more external resources (e.g., a list of one or more nearby devices, e.g., from a cellular network device listener, or a positioning system locating sensor, or a Wi-Fi radio detector) configured to be used to manipulate data (e.g., similarly to as above, one or more of the devices of the list of nearby devices can manipulate the data from a user into data that is acceptable by the vendor, e.g., one or more of the devices may be able to generate and transmit a QR code) into a result suitable for use by at least one vendor payment channel (e.g., using a QR code as a vendor payment modality).

Referring again to FIG. 9D, operation 924 may include operation 936 depicting selecting an external resource from the list of one or more external resources. For example, FIG. 5, e.g., FIG. 5D, shows external resource from the acquired list of one or more external resources selecting module 536 selecting an external resource (e.g., one of the nearby devices) from the list of one or more external resources (e.g., the list mentioned above, of one or more nearby devices).

Referring again to FIG. 9D, operation 934 may include operation 938 depicting receiving a list, from a vendor having the vendor payment channel set, of one or more external resources configured to be used to manipulate data into a result suitable for use by at least one vendor payment channel. For example, FIG. 5, e.g., FIG. 5D, shows list of one or more external resources configured to manipulate transaction data for use by at least one vendor payment channel of the vendor payment channel set acquiring from a vendor using the vendor payment channel set module 538 receiving a list (e.g., a list of external resources, e.g., local smartphone and tablet devices), from a vendor having the vendor payment channel set (e.g., a coffee shop as the vendor, which receives the list from the free wireless Internet services provided at the coffee shop), of one or more external resources (e.g., smartphones, tablet devices, and laptops) configured to be used to manipulate data (e.g., convert data from one format into another) into a result suitable for use by at least one vendor payment channel (e.g., the vendor payment channel uses credit card with signature in a .bitmap format, and the user's device only has the signature in a JPEG format).

Referring again to FIG. 9D, operation 936 may include operation 940 depicting selecting an external resource from the list of one or more external resources based on the external resource having a common characteristic with a device configured to present the persistent transaction interface. For example, FIG. 5, e.g., FIG. 5D, shows external resource from the acquired list of one or more external resources selecting based on a common characteristic with a device configured to present the abiding device-based interchange module 540 selecting an external resource (e.g., a particular smartphone device) from the list of one or more external resources (e.g., smartphones, tablet devices, and laptops) based on the external resource having a common characteristic (e.g., they both have a 4G LTE cellular network antenna for transmitting data) with a device (e.g., the user's device, e.g., the user's smartphone device) configured to present the persistent transaction interface (e.g., to display the persistent button on the screen).

Referring again to FIG. 9D, operation 940 may include operation 942 depicting selecting an external resource from the list of one or more external resources based on the external resource having a same operating system as the device configured to present the persistent transaction interface. For example, FIG. 5, e.g., FIG. 5D, shows external resource from the acquired list of one or more external resources selecting based on having one or more same applications as the device configured to present the abiding device-based interchange module 542 selecting an external resource (e.g., a particular tablet device) from the list of one or more external resources (e.g., a list of tablet devices within fifteen feet of the device that have their wireless radios on) based on the external resource (e.g., a selected tablet device) having a same operating system (e.g., Android-branded operating system) as the device (e.g., the user's smartphone or tablet device) configured to present the persistent transaction interface (e.g., a persistent button of the device).

Referring now to FIG. 9E, operation 936 may include operation 944 depicting selecting an external resource from the list of one or more external resources based on a transaction cost indicated by the external resource. For example, FIG. 5, e.g., FIG. 5E. shows external resource from the acquired list of one or more external resources selecting based on a price quoted for a use of the external resource module 544 selecting an external resource (e.g., a particular smartphone device by “User X”) from the list of one or more external resources (e.g., smartphone devices owned by Users A-Z) based on a transaction cost (e.g., User X takes 0.02% of the transaction total cost as her fee, which is the lowest for all the users A-Z) indicated by the external resource (e.g., user X has set her phone to broadcast that she takes 0.02% of the transaction total cost).

Referring again to FIG. 9E, operation 936 may include operation 946 depicting selecting an external resource from the list of one or more external resources based on a pre-existing relationship with the external resource. For example, FIG. 5, e.g., FIG. 5E, shows external resource from the acquired list of one or more external resources selecting based on a pre-existing relationship between the external resource and a device configured to present the abiding device-based interchange resource module 546 selecting an external resource (e.g., a child's smartphone, which has limited access to one or more accounts for purchasing things, selects an external resource that is the parent's phone, which has the account information for purchase) from the list of one or more external resources (e.g., a list of all the nearby smartphones, regardless of whether they are related to the user) based on a pre-existing relationship (e.g., the devices are on the same plan and are related as parent and child device) with the external resource (e.g., the parent's phone, which contains the parent's credit card.

Referring now to FIG. 9F, operation 606 may include operation 948 depicting contacting one or more resources configured to be used to manipulate data into a result suitable for use by at least one vendor payment channel from the determined at least one vendor payment channel set, said one or more resources having a prior relationship with a device configured to present the persistent transaction interface. For example, FIG. 5, e.g., FIG. 5F, shows one or more resources related to carrying out at least a portion of the potential transaction using the acquired vendor payment channel set and associated with a device configured to present the abiding device-based interface locating module 548 contacting one or more resources (e.g., a provider of an online application store where the user of the device has previously made purchases) configured to be used to manipulate data (e.g., to take the user's verification data identifying the user, and manipulating the identifying data into financial data, e.g., data about the credit card that was used by the user to purchase one or more items from the online application store) into a result suitable for use (e.g., credit card information) by at least one vendor payment channel (e.g., a vendor payment option of credit card and a vendor payment modality of credit card data with authentication code) from the determined at least one vendor payment channel set, said one or more resources (e.g., the provider of the online application store) having a prior relationship (e.g., the user previously purchased something from the online application store) a device configured to present the persistent transaction interface.

Referring again to FIG. 9F, operation 948 may include operation 950 depicting contacting one or more resources configured to be used to manipulate data into a result suitable for use by at least one vendor payment channel from the determined at least one vendor payment channel set, said one or more resources operating under a related contract as a device configured to present the persistent transaction interface. For example, FIG. 5, e.g., FIG. 5F, shows one or more resources related to carrying out at least a portion of the potential transaction using the acquired vendor payment channel set and operating under a related contract with a device configured to present the abiding device-based interface locating module 550 contacting one or more resources (e.g., other cellular telephone devices) configured to be used to manipulate data (e.g., transform data from one form into another) into a result suitable for use by at least one vendor payment channel (e.g., using PayPal as a payment option) from the determined at least one vendor payment channel set, said one or more resources (e.g., the other cellular telephone device) operating under a related contract (e.g., the other cellular telephone device has a same services provider) as a device configured to present the persistent transaction interface (e.g., the user's device that provided the persistent payment button on the screen).

Referring again to FIG. 9F, operation 606 may include operation 952 depicting determining one or more applications present on a device configured to be used to carry out at least a portion of the potential transaction using at least one vendor payment channel from the determined at least one vendor payment channel set. For example, FIG. 5, e.g., FIG. 5F, shows one or more applications configured to carrying out at least a portion of the potential transaction using the acquired vendor payment channel set identifying module 552 determining one or more applications (e.g., a Bluetooth controller) present on a device (e.g., a tablet device) configured to be used to carry out at least a portion of the potential transaction (e.g., purchasing a coffee at a coffee shop) using at least one vendor payment channel (e.g., transmitting financial data across a cellular network, which the tablet device does not have access to, so the Bluetooth controller is used to communicate with another device reachable by Bluetooth to send the financial data to that device, which can then relay the financial data using its own cellular network, to the vendor) from the determined at least one vendor payment channel set (e.g., a payment channel set including communicating financial data using a cellular network).

Referring again to FIG. 9F, operation 952 may include operation 954 depicting determining one or more applications that are configured to store data that is configured to be used to carry out at least a portion of the potential transaction using at least one vendor payment channel from the determined at least one vendor payment channel set. For example, FIG. 5, e.g., FIG. 5F, shows one or more applications configured to store data that may assist in carrying out at least a portion of the potential transaction using the acquired vendor payment channel set identifying module 554 determining one or more applications (e.g., an email application) that are configured to store data (e.g., a PIN number for a credit card that was sent in an email from the bank to the user) that is configured to be used to carry out at least a portion of the potential transaction (e.g., paying for a drink at a bar) using at least one vendor payment channel (e.g., debit card with PIN, where the device application has access to the debit card number, but not the pin, which is why it obtains it from the email application) from the determined at least one vendor payment channel set (e.g., a payment channel set including “debit card with PIN” as one of the vendor payment modalities).

Referring again to FIG. 9F, operation 952 may include operation 956 depicting determining one or more applications that have a permission to access data that is configured to be used to carry out at least a portion of the potential transaction using at least one vendor payment channel from the determined at least one vendor payment channel set. For example, FIG. 5, e.g., FIG. 5F, shows one or more applications configured to have a permission to access data that assist in carrying out at least a portion of the potential transaction using the acquired vendor payment channel set identifying module 556 determining one or more applications (e.g., a web browser that stores cookie data that has access to financial information, e.g., passwords to bank accounts that can be used to access the account to complete a transaction, or credit card numbers, or pin numbers) that have a permission to access data (e.g., data inside the cookie) that is configured to be used to carry out at least a portion of the potential transaction (e.g., purchasing groceries) using at least one vendor payment channel (e.g., bank delta debit card) from the determined at least one vendor payment channel set (e.g., three payment options (e.g., bank gamma debit card, bank delta debit card, corporate credit card).

Referring again to FIG. 9F, operation 952 may include operation 958 depicting polling a device to determine a list of one or more applications that have access to data configured to be used to carry out at least a portion of the potential transaction using at least one vendor payment channel from the determined at least one vendor payment channel set. For example, FIG. 5, e.g., FIG. 5F, shows device analyzing to identify one or more applications configured to carry out at least a portion of the potential transaction using the acquired vendor payment channel set module 558 polling a device (e.g., a smartphone device) to determine a list of one or more applications (e.g., a bank management application, a mapping application, a gas tracking application, and an e-mail application) that have access to data (e.g., financial data, position data) configured to be used to carry out at least a portion of the potential transaction (e.g., buying electronics from a vendor-specific electronics store, e.g., the Apple Store) using at least one vendor payment channel (e.g., Visa-branded credit cards as a vendor payment option) from the determined at least one vendor payment channel set (e.g., two vendor payment options including Visa-branded credit cards and PaySure-branded credit cards).

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in an embodiment,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
facilitating presentation of a persistent transaction interface;
determining a vendor payment channel set for facilitating a potential transaction that corresponds to the presentation of the persistent transaction interface; and
determining one or more resources configured to be used to carry out at least a portion of the potential transaction using at least one vendor payment channel from the determined at least one vendor payment channel set.

2. The computationally-implemented method of claim 1, wherein said facilitating presentation of a persistent transaction interface comprises:
facilitating presentation of a persistent transaction interface of a device.

3. The computationally-implemented method of claim 2, wherein said facilitating presentation of a persistent transaction interface of a device comprises:
facilitating presentation of a persistent transaction interface of the device, said device associated with at least one client.

4. The computationally-implemented method of claim 3, wherein said displaying a button designated as a transaction executing button on a screen of the device, said device associated with at least one client comprises:
displaying a persistent transaction interface on a screen of the device, said device associated with at least one client.

5. (canceled)

6. (canceled)

7. (canceled)

8. (canceled)

9. The computationally-implemented method of claim 1, wherein said facilitating presentation of a persistent transaction interface comprises:
facilitating presentation of a transaction interface configured to provide a same option for interaction with the interface independently of one or more vendor payment channels used by the vendor.

10. (canceled)

11. The computationally-implemented method of claim 1, wherein said facilitating presentation of a persistent transaction interface comprises:
facilitating presentation of a transaction interface configured to provide a same option for interaction with the interface independently of one or more client payment channels to be used in the potential transaction.

12. The computationally-implemented method of claim 11, wherein said facilitating presentation of a transaction interface configured to provide a same option for interaction with the interface independently of one or more client payment channels to be used in the potential transaction comprises:
facilitating presentation of a transaction interface configured to provide a same option for interaction with the interface when the potential transaction uses a first client payment channel and when the potential transaction uses a second client payment channel.

13. The computationally-implemented method of claim 1, wherein said facilitating presentation of a persistent transaction interface comprises:
facilitating a display of a persistent button on a screen of a device.

14. The computationally-implemented method of claim 13, wherein said facilitating a display of a persistent button on a screen of a device comprises:
facilitating a display of a persistent button on a screen of the device that maintains one or more same display characteristics.

15. The computationally-implemented method of claim 14, wherein said facilitating a display of a persistent button on a screen of the device that maintains one or more same display characteristics comprises:
facilitating a display of a persistent button on a screen of the device that maintains a same position on the screen.

16. (canceled)

17. The computationally-implemented method of claim 14, wherein said facilitating a display of a persistent button on a screen of the device that maintains one or more same display characteristics comprises:
intercepting one or more instructions from one or more other applications that are configured to alter one or more elements displayed on the screen of the device at the location of the persistent button.

18. (canceled)

19. The computationally-implemented method of claim 1, wherein said facilitating presentation of a persistent transaction interface comprises:
configuring a persistent transaction interface of a device to trigger facilitation of the potential transaction.

20. (canceled)

21. The computationally-implemented method of claim 19, wherein said configuring a persistent transaction interface of a device to trigger facilitation of the potential transaction comprises:
configuring a pressable button of a device that is configured to be supplied to a user by a vendor, to trigger facilitation of the potential transaction between the user and the vendor when the user presses the button.

22. The computationally-implemented method of claim 1, wherein said facilitating presentation of a persistent transaction interface comprises:
facilitating presentation of one or more alterations of a perception of a reality through mediated reality that form a persistent transaction interface.

23. The computationally-implemented method of claim 22, wherein said facilitating presentation of one or more alterations of a perception of a reality through mediated reality that form a persistent transaction interface comprises:
facilitating presentation of one or more portions of a scene through augmented reality, said one or more portions of the scene forming the persistent transaction interface.

24. (canceled)

25. The computationally-implemented method of claim 23, wherein said facilitating presentation of one or more portions of a scene through augmented reality, said one or more portions of the scene forming the persistent transaction interface comprises:
facilitating presentation of a heads-up display that appears in an augmented reality environment of a client, said heads up display forming the persistent transaction interface.

26. The computationally-implemented method of claim 1, wherein said facilitating presentation of a persistent transaction interface comprises:
facilitating presentation of the persistent transaction interface that is configured to receive as input one or more gesticulations.

27. (canceled)

28. (canceled)

29. The computationally-implemented method of claim 1, wherein said facilitating presentation of a persistent transaction interface comprises:
facilitating presentation of the persistent transaction interface at a device configured to assist in carrying out one or more transactions.

30. (canceled)

31. (canceled)

32. (canceled)

33. (canceled)

34. The computationally-implemented method of claim 1, wherein said determining a vendor payment channel set for facilitating a potential transaction that corresponds to the presentation of the persistent transaction interface comprises:
determining a vendor payment channel set that is configured to be used for facilitation of the potential transaction in response to receipt of a signal, from a device interface controller, that the persistent transaction interface of the device has been activated.

35. (canceled)

36. (canceled)

37. (canceled)

38. (canceled)

39. (canceled)

40. (canceled)

41. The computationally-implemented method of claim 1, wherein said determining a vendor payment channel set for facilitating a potential transaction that corresponds to the presentation of the persistent transaction interface comprises:
determining a vendor payment channel set for facilitating a potential transaction prior to facilitating the presentation of the persistent transaction interface.

42. The computationally-implemented method of claim 1, wherein said determining a vendor payment channel set for facilitating a potential transaction that corresponds to the presentation of the persistent transaction interface comprises:
determining a vendor payment channel set for facilitating a potential transaction; and
facilitating the presentation of the persistent transaction interface after determination of the vendor payment channel set.

43. The computationally-implemented method of claim 42, wherein said facilitating the presentation of the persistent transaction interface after determination of the vendor payment channel set comprises:
obscuring the presentation of the persistent transaction interface until the determination of the vendor payment channel set has occurred.

44. (canceled)

45. The computationally-implemented method of claim 42, wherein said facilitating the presentation of the persistent transaction interface after determination of the vendor payment channel set comprises:
preventing the presentation of the persistent transaction interface until the determination of the vendor payment channel set has occurred.

46. The computationally-implemented method of claim 1, wherein said determining a vendor payment channel set for facilitating a potential transaction that corresponds to the presentation of the persistent transaction interface comprises:
determining a vendor payment channel set for facilitating a potential transaction; and
facilitating the presentation of the persistent transaction interface that is configured to use at least one vendor payment channel of the vendor payment channel set for facilitating the potential transaction.

47. (canceled)

48. The computationally-implemented method of claim 1, wherein said determining a vendor payment channel set for facilitating a potential transaction that corresponds to the presentation of the persistent transaction interface comprises:
determining a vendor payment channel set for facilitating a potential transaction that corresponds to the presentation of the persistent transaction interface, said persistent transaction interface designed to obscure the determined vendor payment channel set from an entity configured to observe the persistent transaction interface.

49. (canceled)

50. (canceled)

51. The computationally-implemented method of claim 1, wherein said determining one or more resources configured to be used to carry out at least a portion of the potential transaction using at least one vendor payment channel from the determined at least one vendor payment channel set comprises:
determining one or more data tables configured to be used to carry out at least portion of the potential transaction using at least one vendor payment channel from the determined at least one vendor payment channel set.

52. (canceled)

53. The computationally-implemented method of claim 1, wherein said determining one or more resources configured to be used to carry out at least a portion of the potential transaction using at least one vendor payment channel from the determined at least one vendor payment channel set comprises:
determining a location of one or more information resources containing data related to at least one vendor payment channel from the vendor payment channel set.

54. (canceled)

55. The computationally-implemented method of claim 1, wherein said determining one or more resources configured to be used to carry out at least a portion of the potential transaction using at least one vendor payment channel from the determined at least one vendor payment channel set comprises:
determining one or more resources configured to be used to convert data into a format used by at least one vendor payment channel from the determined at least one vendor payment channel set.

56. The computationally-implemented method of claim 55, wherein said determining one or more resources configured to be used to convert data into a format used by at least one vendor payment channel from the determined at least one vendor payment channel set comprises:
determining one or more resources configured to be used to convert data stored on a device configured to present the persistent transaction interface into the format used by the at least one vendor payment channel from the determined at least one vendor payment channel set.

57. The computationally-implemented method of claim 56, wherein said determining one or more resources configured to be used to convert data stored on a device configured to present the persistent transaction interface into the format used by the at least one vendor payment channel from the determined at least one vendor payment channel set comprises:
determining one or more resources configured to be used to convert user payment channel data stored on a device configured to present the persistent transaction interface into the format used by the at least one vendor payment channel from the determined at least one vendor payment channel set.

58. The computationally-implemented method of claim 57, wherein said determining one or more resources configured to be used to convert user payment channel data stored on a device configured to present the persistent transaction interface into the format used by the at least one vendor payment channel from the determined at least one vendor payment channel set comprises:
determining one or more resources configured to be used to convert at least one user payment channel of a user payment channel set stored on the device configured to present the persistent transaction interface into the format used by the at least one vendor payment channel from the determined at least one vendor payment channel set.

59. (canceled)

60. The computationally-implemented method of claim 1, wherein said determining one or more resources configured to be used to carry out at least a portion of the potential transaction using at least one vendor payment channel from the determined at least one vendor payment channel set comprises:
determining one or more resources configured to be used to manipulate data into a result suitable for use by at least one vendor payment channel from the determined at least one vendor payment channel set.

61. The computationally-implemented method of claim 60, wherein said determining one or more resources configured to be used to manipulate data into a result suitable for use by at least one vendor payment channel from the determined at least one vendor payment channel set comprises:
determining one or more external resources configured to be used to manipulate data into a result suitable for use by at least one vendor payment channel from the determined at least one vendor payment channel.

62. (canceled)

63. (canceled)

64. The computationally-implemented method of claim 61, wherein said determining one or more external resources configured to be used to manipulate data into a result suitable for use by at least one vendor payment channel from the determined at least one vendor payment channel comprises:
determining one or more external resources controlled by a vendor, said one or more external resources configured to be used to manipulate data into a result suitable for use by at least one vendor payment channel from the determined at least one vendor payment channel.

65. (canceled)

66. The computationally-implemented method of claim 61, wherein said determining one or more external resources configured to be used to manipulate data into a result suitable for use by at least one vendor payment channel from the determined at least one vendor payment channel comprises:
receiving a list of one or more external resources configured to be used to manipulate data into a result suitable for use by at least one vendor payment channel; and
selecting an external resource from the list of one or more external resources.

67. (canceled)

68. The computationally-implemented method of claim 66, wherein said selecting an external resource from the list of one or more external resources comprises:
selecting an external resource from the list of one or more external resources based on the external resource having a common characteristic with a device configured to present the persistent transaction interface.

69. (canceled)

70. (canceled)

71. The computationally-implemented method of claim 66, wherein said selecting an external resource from the list of one or more external resources comprises:
selecting an external resource from the list of one or more external resources based on a pre-existing relationship with the external resource.

72. The computationally-implemented method of claim 1, wherein said determining one or more resources configured to be used to carry out at least a portion of the potential transaction using at least one vendor payment channel from the determined at least one vendor payment channel set comprises:
contacting one or more resources configured to be used to manipulate data into a result suitable for use by at least one vendor payment channel from the determined at least one vendor payment channel set, said one or more resources having a prior relationship with a device configured to present the persistent transaction interface.

73. (canceled)

74. The computationally-implemented method of claim 1, wherein said determining one or more resources configured to be used to carry out at least a portion of the potential transaction using at least one vendor payment channel from the determined at least one vendor payment channel set comprises:
determining one or more applications present on a device configured to be used to carry out at least a portion of the potential transaction using at least one vendor payment channel from the determined at least one vendor payment channel set.

75. (canceled)

76. The computationally-implemented method of claim 74, wherein said determining one or more applications present on a device configured to be used to carry out at least a portion of the potential transaction using at least one vendor payment channel from the determined at least one vendor payment channel set comprises:
determining one or more applications that have a permission to access data that is configured to be used to carry out at least a portion of the potential transaction using at least one vendor payment channel from the determined at least one vendor payment channel set.

77-156. (canceled)

157. A device defined by a computational language comprising:
one or more interchained physical machines ordered for facilitating presentation of a persistent transaction interface;
one or more interchained physical machines ordered for determining a vendor payment channel set for facilitating a potential transaction that corresponds to the presentation of the persistent transaction interface; and
one or more interchained physical machines ordered for determining one or more resources configured to be used to carry out at least a portion of the potential transaction using at least one vendor payment channel from the determined at least one vendor payment channel set.
